(19) United States
(12) Patent Application Publication
(10) Pub. No.: US 2021/0354731 A1
(43) Pub. Date: Nov. 18, 2021

(54) METHOD AND SYSTEM FOR IDENTIFYING TRAVELING BACKWARD PASSENGERS AND BOARDING TRAINS IN RAIL TRANSIT

(71) Applicant: Beijing Jiaotong University, Beijing (CN)

(72) Inventors: Xinyue XU, Beijing (CN); Haiying LI, Beijing (CN); Jun LIU, Beijing (CN); Chao YU, Beijing (CN); Jianmin LI, Beijing (CN)

(21) Appl. No.: 17/138,493

(22) Filed: Dec. 30, 2020

(30) Foreign Application Priority Data
May 18, 2020 (CN) 202010418186.8

(51) Int. Cl. B61D 41/04; G06Q 10/02; G06Q 10/04; G06F 17/18

(52) U.S. Cl. CPC B61D 41/04; G06F 17/18; G06Q 10/047; G06Q 10/02

(57) ABSTRACT

A method and system for identifying traveling backward (TB) passengers and boarding trains in rail transit is provided. The method includes: establishing a passenger choice behavior model based on a waiting time of passengers, identifying normal passengers and TB passengers, and determining a normal waiting time and a turn-back time; establishing a normal waiting time distribution model based on the maximum number of trains and the waiting time of normal passengers; establishing a turn-back time distribution model based on the maximum number of turn-back stations and the turn-back time; and identifying TB passengers, turn-back stations and boarding trains of TB passengers and boarding trains of normal passengers according to the estimated parameters. The method and system of the present disclosure provide a more accurate and reasonable basis for passenger flow control and transport capacity allocation.

### CROSS-REFERENCE TO PRIOR APPLICATIONS

The present application is based on and claims priority to China Patent Application 202010418186.8, filed May 18, 2020, the contents of which are incorporated herein by reference.

### TECHNICAL FIELD

The present disclosure relates to the technical field of rail transit, in particular to a method and system for identifying traveling backward (TB) passengers and boarding trains in rail transit.

### BACKGROUND

In recent years, with the increase in urban population, more urban residents are choosing to travel by metro, which causes serious congestion on some metro lines. In order to tackle with metro congestion, people begin to use the strategies of guiding passengers away from congested lines (that is, passenger flow control). By further improving these control strategies and understanding the nature of the route choice behavior of passengers, the congestion of the metro during peak hours can be effectively relieved.

With the increase in public demand for metros, a large number of passengers fail to board the first arriving train because of its high load. Some passengers choose to travel backward (TB) to obtain seats or avoid congestion. They first take a metro train in the opposite direction to a turn-back station, and then take a train of normal direction at the turn-back station to the destination station. By contrast, passengers who normally travel (normal passengers) do not adopt the TB strategy but directly take a train heading to the destination station. The current rail transit passenger flow distribution methods only consider normal passengers, ignoring TB passengers, and cannot provide an accurate and reasonable basis for passenger flow control and transport capacity allocation.

### SUMMARY

An objective of the present disclosure is to provide a method and system for identifying traveling backward (TB) passengers and boarding trains in rail transit. The present disclosure considers both TB passengers and normal passengers, and provides a more accurate and reasonable basis for passenger flow control and transport capacity allocation.

To achieve the above purpose, the present disclosure provides the following technical solutions.

A method for identifying traveling backward (TB) passengers and boarding trains in rail transit includes:

acquiring data of ridership from an automatic fare collection (AFC) system, and determining a waiting time of passengers according to the ridership data, where the waiting time includes a normal waiting time of normal passengers and a turn-back time of TB passengers; the normal waiting time is a time when the normal passengers wait at a station for a train directly into a destination station; the turn-back time is the sum of an in-vehicle time when the TB passengers travel in an opposite direction and a waiting time of the TB passengers at an origin station and a turn-back station;

establishing a passenger choice behavior model according to the waiting time of the passengers, where a passenger choice behavior includes normal travel and TB;

acquiring the maximum number of trains the passengers have to wait for and the maximum number of turn-back stations;

establishing a normal waiting time distribution model for normal passengers boarding different trains according to the maximum number of trains and the normal waiting time;

establishing a turn-back time distribution model for TB passengers choosing different turn-back stations according to the maximum number of turn-back stations and the turn-back time;

calculating a joint posterior probability of parameters in the passenger choice behavior model, the normal waiting time distribution model and the turn-back time distribution model by using a Bayesian model to obtain the joint posterior probability of the parameters of each model;

using a no-u-turn sampler (NUTS) algorithm to estimate the parameters in each joint posterior probability to obtain estimated parameters; and

identifying TB passengers, turn-back stations and boarding trains of TB passengers and boarding trains of normal passengers according to the estimated parameters to obtain an identification result.

Optionally, the establishing a passenger choice behavior model according to the waiting time of the passengers specifically includes:

establishing a passenger choice behavior model according to the following equation:

$$\begin{matrix}p ( z ∈ NP \vert {t}_{r , o , d}^{W} ( z ) ) = \frac{{ω}_{r , o , d}^{0} \frac{1}{\sqrt{2 π} \cdot {σ}_{r , o , d}^{0}} {e}^{\frac{- {( {t}_{r , o , d}^{W} ( z ) - {μ}_{r , o , d}^{0} )}^{2}}{2 {σ}_{r , o , {d}^{2}}^{0}}}}{\begin{matrix}{ω}_{r , o , d}^{0} \frac{1}{\sqrt{2 π} \cdot {σ}_{r , o , d}^{0}} {e}^{\frac{- {( {t}_{r , o , d}^{W} ( z ) - {μ}_{r , o , d}^{0} )}^{2}}{2 {σ}_{r , o , {d}^{2}}^{0}}} + \\ {ω}_{r , o , d}^{1} \frac{1}{\sqrt{2 π} \cdot {σ}_{r , o , d}^{1}} {e}^{\frac{- {( {t}_{r , o , d}^{W} ( z ) - {μ}_{r , o , d}^{1} )}^{2}}{2 {σ}_{r , o , {d}^{2}}^{1}}}\end{matrix}} & \\ p ( z ∈ TBP \vert {t}_{r , o , d}^{W} ( z ) ) = 1 - p ( z ∈ NP \vert {t}_{r , o , d}^{W} ( z ) ) & \end{matrix}$$

where, p(z∈NP|t_{r,o,d}^{w}(z)) represents a probability that passenger z is a normal passenger; p(z∈TBP|t_{r,o,d}^{w}(z)) represents a probability that passenger z is a TB passenger; NP represents a set of all normal passengers; TBP represents a set of all TB passengers; t_{r,o,d}^{w}(z) represents the waiting time of passenger z, who chooses route r, at origin station o; μ_{r,o,d}⁰, σ_{r,o,d}⁰ and ω_{r,o,d}⁰ respectively represent a mean vector, a standard deviation vector and a weight vector of the normal waiting time of normal passengers, who choose route r, at origin station o; μ_{r,o,d}¹, σ_{r,o,d}¹ and ω_{r,o,d}¹ respectively represent a mean vector, a standard deviation vector and a weight vector of the turn-back time of TB passengers, who choose route r, at origin station o.

Optionally, the establishing a normal waiting time distribution model for normal passengers boarding different trains according to the maximum number of trains and the normal waiting time specifically includes:

establishing a normal waiting time distribution model according to the following equation:

$$p ( {t}_{r , o , d}^{W} ( z ) \vert {ω}_{r , o , d}^{0} , {μ}_{r , o , d}^{0} , {σ}_{r , o , d}^{0} ) = {\sum }_{i = 1}^{{K}_{r , o , d}^{0}} ( {ω}_{r , o , d}^{0 , i} \frac{1}{\sqrt{2 π} \cdot {σ}_{r , o , d}^{0 , i}} {e}^{\frac{- {( {t}_{r , o , d}^{W} ( z ) - {μ}_{r , o , d}^{0 , i} )}^{2}}{2 {σ}_{r , o , {d}^{2}}^{0 , i}}} )$$

where, K_{r,o,d}⁰ represents the maximum number of trains that passenger z who chooses route r needs to wait at origin station o; p(t_{r,o,d}^{W}(z)|ω_{r,o,d}⁰,μ_{r,o,d}⁰,σ_{r,o,d}⁰) represents a probability density function for the distribution of all normal waiting time; ω_{r,o,d}⁰=(ω_{r,o,d}^{0,1},ω_{r,o,d}^{0,2}, . . . ω_{r,o,d}^{0,i}, . . . , ω_{r,o,d}^{0,K}^{_{r,o,d}}^{⁰}) represents a weight vector for the waiting time of normal passengers waiting for an i-th metro; μ_{r,o,d}⁰=(μ_{r,o,d}^{0,1},μ_{r,o,d}^{0,2}, . . . μ_{r,o,d}^{0,i}, . . . , μ_{r,o,d}^{0,K}^{_{r,o,d}}^{⁰}) σ_{r,o,d}⁰=(σ_{r,o,d}^{0,1},σ_{r,o,d}^{0,2}, . . . σ_{r,o,d}^{0,i}, . . . , σ_{r,o,d}^{0,K}^{_{r,o,d}}^{⁰}) respectively represent a mean vector and a standard deviation vector of the normal waiting time of normal passengers waiting for the i-th metro;

the establishing a turn-back time distribution model for TB passengers choosing different turn-back stations according to the maximum number of turn-back stations and the turn-back time specifically includes:

establishing a turn-back time distribution model according to the following equation:

$$p ( {t}_{r , o , d , j}^{T B} \vert {ω}_{r , o , d}^{1} , {μ}_{r , o , d}^{1} , {σ}_{r , o , d}^{1} ) = {\sum }_{j = 1}^{{K}_{r , o , d}^{1}} ( {ω}_{r , o , d}^{1 , j} \frac{1}{\sqrt{2 π} \cdot {σ}_{r , o , d}^{1 , j}} {e}^{\frac{- {( {t}_{r , o , d , j}^{T B} - {μ}_{r , o , d}^{1 , j} )}^{2}}{2 {σ}_{r , o , d}^{1 , j 2}}} )$$

where p(t_{r,o,d,j}^{TB}|ω_{r,o,d}¹,μ_{r,o,d}¹,σ_{r,o,d}¹) represents a probability density function for the distribution of all turn-back time; K_{r,o,d}¹ represents the maximum number of turn-back stations; t_{r,o,d,j}^{TB} represents an average turn-back time of TB passengers between origin station o and turn-back station s_{r,o,d}^{j} on route r; ω_{r,o,d}¹=(ω_{r,o,d}^{1,1}, . . . , ω_{r,o,d}^{1,j}, . . . , ω_{r,o,d}^{1,K}^{_{r,o,d}}^{¹}) represents a weight vector for the turn-back time of TB passenger at a j-th turn-back station; μ_{r,o,d}¹=(μ_{r,o,d}^{1,1}, . . . , μ_{r,o,d}^{1,j}, . . . , μ_{r,o,d}^{1,K}^{_{r,o,d}}^{^{tb}}) and σ_{r,o,d}¹=(σ_{r,o,d}^{1,1}, . . . σ_{r,o,d}^{1,j}, . . . , σ_{r,o,d}^{1,K}^{_{r,o,d}}^{¹}) represent a mean vector and a standard deviation vector of the turn-back time of TB passengers at the j-th turn-back station, respectively.

Optionally, the calculating a joint posterior probability of parameters in the passenger choice behavior model, the normal waiting time distribution model and the turn-back time distribution model by using a Bayesian model to obtain the joint posterior probability of the parameters of each model specifically includes:

taking the normal waiting time as observation data and the probability distribution function of the normal waiting time of normal passengers taking different trains as a likelihood function, and obtaining an initial expression of the joint posterior probability of the parameters in the normal waiting time distribution model according to the Bayesian equation;

determining a joint prior probability function of the parameters according to mean, standard deviation and weight vectors of the normal waiting time of normal passengers waiting for the i-th metro;

calculating a probability of the waiting time of passengers according to the mean, standard deviation and weight vectors of the normal waiting time of normal passengers, who choose route r, at origin station o;

determining a likelihood function of the observation data based on the observation data; and

determining an actual joint posterior probability of parameters according to the initial expression of the joint posterior probability of parameters, the joint prior probability function, the probability of the normal waiting time of passengers and the likelihood function of the observation data.

Optionally, after identifying TB passengers, turn-back stations and boarding trains of TB passengers and boarding trains of normal passengers according to the estimated parameters to obtain an identification result, the method further includes:

calculating the waiting time at each station and a loading rate in each running section according to the identification result.

A system for identifying TB passengers and boarding trains in rail transit includes:

a ridership data acquisition module, for acquiring data of ridership from an AFC system, and determining a waiting time of passengers according to the ridership data, where the waiting time includes a normal waiting time of normal passengers and a turn-back time of TB passengers; the normal waiting time is a time when the normal passengers wait at a station for a train directly into a destination station; the turn-back time is the sum of an in-vehicle time when the TB passengers travel in an opposite direction and a waiting time of the TB passengers at an origin station and a turn-back station;

a passenger choice behavior model establishing module, for establishing a passenger choice behavior model according to the waiting time of the passengers, where a passenger choice behavior includes normal travel and TB;

a train and station data acquisition module, for acquiring the maximum number of trains passengers have to wait for and the maximum number of turn-back stations;

a normal waiting time distribution model establishing module, for establishing a normal waiting time distribution model for normal passengers boarding different trains according to the maximum number of trains and the normal waiting time;

a turn-back time distribution model establishing module, for establishing a turn-back time distribution model for TB passengers choosing different turn-back stations according to the maximum number of turn-back stations and the turn-back time;

a joint posterior probability calculation module, for calculating a joint posterior probability of parameters in the passenger choice behavior model, the normal waiting time distribution model and the turn-back time distribution model by using a Bayesian model to obtain the joint posterior probability of the parameters of each model;

a parameter estimation module, for using a NUTS algorithm to estimate the parameters in each joint posterior probability to obtain estimated parameters; and

an identification module, for identifying TB passengers, turn-back stations and boarding trains of TB passengers and boarding trains of normal passengers according to the estimated parameters to obtain an identification result.

Optionally, the passenger choice behavior model establishing module specifically includes:

a passenger choice behavior model establishing unit, for establishing a passenger choice behavior model according to the following equation:

$$\begin{matrix}p ( z ∈ NP \vert {t}_{r , o , d}^{W} ( z ) ) = \frac{{ω}_{r , o , d}^{0} \frac{1}{\sqrt{2 π} \cdot {σ}_{r , o , d}^{0}} {e}^{\frac{- {( {t}_{r , o , d}^{W} ( z ) - {μ}_{r , o , d}^{0} )}^{2}}{2 {σ}_{r , o , {d}^{2}}^{0}}}}{\begin{matrix}{ω}_{r , o , d}^{0} \frac{1}{\sqrt{2 π} \cdot {σ}_{r , o , d}^{0}} {e}^{\frac{- {( {t}_{r , o , d}^{W} ( z ) - {μ}_{r , o , d}^{0} )}^{2}}{2 {σ}_{r , o , {d}^{2}}^{0}}} + \\ {ω}_{r , o , d}^{1} \frac{1}{\sqrt{2 π} \cdot {σ}_{r , o , d}^{1}} {e}^{\frac{- {( {t}_{r , o , d}^{W} ( z ) - {μ}_{r , o , d}^{1} )}^{2}}{2 {σ}_{r , o , {d}^{2}}^{1}}}\end{matrix}} & \\ p ( z ∈ TBP \vert {t}_{r , o , d}^{W} ( z ) ) = 1 - p ( z ∈ NP \vert {t}_{r , o , d}^{W} ( z ) ) & \end{matrix}$$

where p(z∈NP|t_{r,o,d}^{W}(z)) represents a probability that passenger z is a normal passenger; p(z∈TBP|t_{r,o,d}^{W}(z)) represents a probability that passenger z is a TB passenger; NP represents a set of all normal passengers; TBP represents a set of all TB passengers; t_{r,o,d}^{W}(z) represents the waiting time of passenger z, who chooses route r, at origin station o; μ_{r,o,d}⁰, σ_{r,o,d}⁰ and ω_{r,o,d}⁰ respectively represent a mean vector, a standard deviation vector and a weight vector of the normal waiting time of normal passengers, who choose route r, at origin station o; μ_{r,o,d}¹, σ_{r,o,d}¹ and ω_{r,o,d}¹ respectively represent a mean vector, a standard deviation vector and a weight vector of the turn-back time of TB passengers, who choose route r, at origin station o.

Optionally,

the normal waiting time distribution model establishing module specifically includes:

a normal waiting time distribution model establishing unit, for establishing a normal waiting time distribution model according to the following equation:

$$p ( {t}_{r , o , d}^{W} ( z ) \vert {ω}_{r , o , d}^{0} , {μ}_{r , o , d}^{0} , {σ}_{r , o , d}^{0} ) = {\sum }_{i = 1}^{{K}_{r , o , d}^{0}} ( {ω}_{r , o , d}^{0 , i} \frac{1}{\sqrt{2 π} \cdot {σ}_{r , o , d}^{0 , i}} {e}^{\frac{- {( {t}_{r , o , d}^{W} ( z ) - {μ}_{r , o , d}^{0 , i} )}^{2}}{2 {σ}_{r , o , {d}^{2}}^{0 , i}}} )$$

where, K_{r,o,d}⁰ represents the maximum number of trains that passenger z who chooses route r needs to wait at origin station o; p(t_{r,o,d}^{W}(z)|ω_{r,o,d}⁰,μ_{r,o,d}⁰,σ_{r,o,d}⁰) represents a probability density function for the distribution of all normal waiting time; ω_{r,o,d}⁰=(ω_{r,o,d}^{0,1},ω_{r,o,d}^{0,2}, . . . , ω_{r,o,d}^{0,i}, . . . , ω_{r,o,d}^{0,K}^{_{r,o,d}}^{⁰}) represents a weight vector for the waiting time of normal passengers waiting for an i-th metro; μ_{r,o,d}⁰=(μ_{r,o,d}^{0,1},μ_{r,o,d}^{0,2}, . . . μ_{r,o,d}^{0,i}, . . . , μ_{r,o,d}^{0,K}^{_{r,o,d}}^{⁰}) and σ_{r,o,d}^{0l =(σ}_{r,o,d}^{0,1}σ_{r,o,d}^{0,2}, . . . σ_{r,o,d}^{0,i}, . . . , σ_{r,o,d}^{0,K}^{_{r,o,d}}^{⁰}) respectively represent a mean vector and a standard deviation vector of the normal waiting time of normal passengers waiting for the i-th metro;

the turn-back time distribution model establishing module specifically includes:

a turn-back time distribution model establishing unit, for establishing a turn-back time distribution model according to the following equation:

$$p ( {t}_{r , o , d , j}^{TB} \vert {ω}_{r , o , d}^{1} , {μ}_{r , o , d}^{1} , {σ}_{r , o , d}^{1} ) = {\sum }_{j = 1}^{{K}_{r , o , d}^{1}} ( {ω}_{r , o , d}^{1 , j} \frac{1}{\sqrt{2 π} \cdot {σ}_{r , o , d}^{1 , j}} {e}^{\frac{- {( {t}_{r , o , d , j}^{TB} - {μ}_{r , o , d}^{1 , j} )}^{2}}{2 {σ}_{r , o , {d}^{2}}^{1 , j}}} )$$

where, p(t_{r,o,d,j}^{TB}|ω_{r,o,d}¹,μ_{r,o,d}¹,σ_{r,o,d}¹) represents a probability density function for the distribution of all turn-back time; K_{r,o,d}¹ represents the maximum number of turn-back stations; t_{r,o,d,j}^{TB} represents an average turn-back time of TB passengers between origin station o and turn-back station s_{r,o,d}^{j} on route r; ω_{r,o,d}¹=(ω_{r,o,d}^{1,1}, . . . ,ω_{r,o,d}^{1,j}, . . . , ω_{r,o,d}^{1,K}^{^{r,o,d}}^{₁}) represents a weight vector for the turn-back time of TB passenger at a j-th turn-back station; μ_{r,o,d}¹=(μ_{r,o,d}^{1,1}, . . . , μ_{r,o,d}^{1,j}, . . . , μ_{r,o,d}^{1,K}^{^{r,o,d}}^{_{kb}}) and σ_{r,o,d}¹=(σ_{r,o,d}^{1,1}, . . . σ_{r,o,d}^{1,j}, . . . , σ_{r,o,d}^{1,K}^{^{r,o,d}}^{₁}) represent a mean vector and a standard deviation vector of the turn-back time of TB passengers at the j-th turn-back station, respectively.

Optionally, the joint posterior probability calculation module specifically includes:

a joint posterior probability initial expression generating unit, for taking the normal waiting time as observation data and the probability distribution function of the normal waiting time of normal passengers taking different trains as a likelihood function, and obtaining an initial expression of the joint posterior probability of the parameters in the normal waiting time distribution model according to the Bayesian equation;

a parameter joint prior probability function determining unit, for determining a joint prior probability function of the parameters according to mean, standard deviation and weight vectors of the normal waiting time of normal passengers waiting for an i-th metro;

a normal waiting time probability calculating unit, for calculating a probability of the waiting time of normal passengers according to the mean, standard deviation and weight vectors of the normal waiting time of normal passengers, who choose route r, at origin station o;

an observation data likelihood function determining unit, for determining a likelihood function of the observation data based on the observation data; and

a parameter joint posterior probability generating unit, for determining an actual joint posterior probability of the parameters according to the initial expression of the joint posterior probability, the joint prior probability function, the probability of the normal waiting time of passengers and the likelihood function of the observation data.

Optionally, the system further includes:

a waiting time and loading rate calculation module, for calculating the waiting time at each station and a loading rate in each running section according to the identification result.

Compared with the prior art, the present disclosure has the following beneficial effects:

The present disclosure provides a method and system for identifying TB passengers and boarding trains in rail transit. This method includes: obtaining data of ridership from an automatic fare collection (AFC) system, and determining a waiting time of passengers; establishing a passenger choice behavior model based on the waiting time of the passengers, taking into account both normal travel and TB; establishing a normal waiting time distribution model based on the maximum number of trains and the waiting time of normal passengers; establishing a turn-back time distribution model based on the maximum number of turn-back stations and a turn-back time; using a Bayesian model to calculate a joint posterior probability of parameters in three models to obtain the joint posterior probability of the parameters of each model, and using a no-u-turn sampler (NUTS) algorithm to estimate the parameters in each joint posterior probability to obtain estimated parameters; and identifying TB passengers, turn-back stations and boarding trains of TB passengers and boarding trains of normal passengers according to the estimated parameters. The present disclosure considers both normal passengers and TB passengers, and can provide a more accurate and reasonable basis for passenger flow control and transport capacity allocation. Meanwhile, the present disclosure estimates the model parameters based on the Bayesian model combined with the NUTS algorithm, increasing the calculation speed and reducing the calculation errors.

### BRIEF DESCRIPTION OF DRAWINGS

To illustrate the embodiments of the present disclosure or the technical solutions of the prior art, the accompanying drawing to be used will be described briefly below. Notably, the following accompanying drawing merely illustrates some embodiments of the present disclosure, but other accompanying drawings can also be obtained those of ordinary skill in the art based on the accompanying drawing without any creative efforts.

FIG. 1 is a flowchart of a method for identifying traveling backward (TB) passengers and boarding trains in rail transit according to an embodiment of the present disclosure.

FIG. 2 shows information regarding target stations according to an embodiment of the present disclosure.

FIG. 3 shows a space-time process of passenger travel in a metro network according to an embodiment of the present disclosure.

FIG. 4 shows a travel process of a single passenger considering a TB behavior according to an embodiment of the present disclosure.

FIG. 5 shows identification results for three origin-destination (OD) pairs with Shahe as the origin station during the morning peak hours in September 2018 according to an embodiment of the present disclosure.

FIG. 6 shows identification results for three OD pairs with Shahe University Park as the origin station during the peak morning hours in September 2018 according to an embodiment of the present disclosure.

FIG. 7 shows the average number of inbound passengers of different stations on the Changping Line during morning peak in September 2018 according to an embodiment of the present disclosure.

FIG. 8 shows the average waiting time of passengers at each station during the morning rush hours according to an embodiment of the present disclosure.

FIG. 9 shows the number of left behind (LB) passengers on the Changping Line during the morning rush hours according to an embodiment of the present disclosure.

FIG. 10 is a schematic diagram of the method according to the embodiment of the present disclosure.

FIG. 11 is a structural diagram of a system for identifying TB passengers and boarding trains in rail transit according to an embodiment of the present disclosure.

### DETAILED DESCRIPTION

The technical solutions in the embodiments of the present disclosure are clearly and completely described below with reference to the accompanying drawings in the embodiments of the present disclosure. Apparently, the described embodiments are merely a part rather than all of the embodiments of the present disclosure. All other embodiments obtained by a person of ordinary skill in the art based on the embodiments of the present disclosure without creative efforts should fall within the protection scope of the present disclosure.

An objective of the present disclosure is to provide a method and system for identifying traveling backward (TB) passengers and boarding trains in rail transit. The present disclosure considers both TB passengers and normal passengers, and provides a more accurate and reasonable basis for passenger flow control and transport capacity allocation.

To make the foregoing objective, features and advantages of the present disclosure clearer and more comprehensible, the present disclosure is further described in detail below with reference to the accompanying drawings and specific embodiments.

### Embodiments

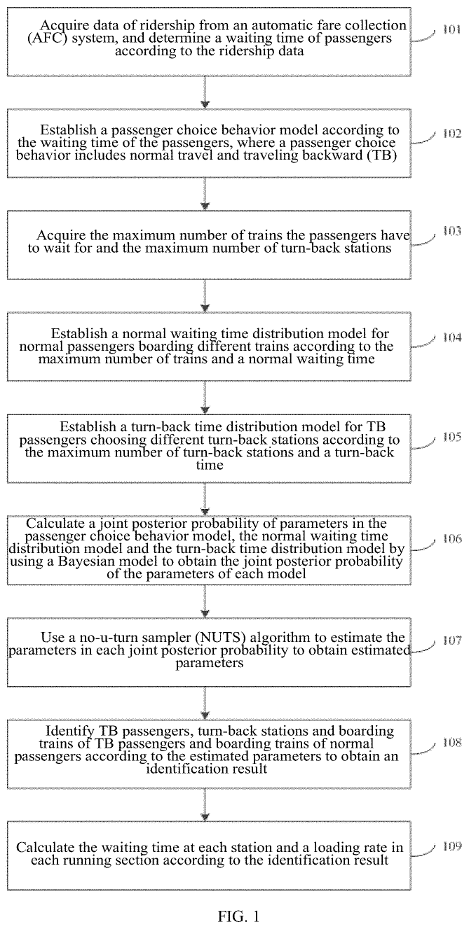

FIG. 1 is a flowchart of a method for identifying TB passengers and boarding trains in rail transit according to an embodiment of the present disclosure. As shown in FIG. 1, the method for identifying TB passengers and boarding trains in rail transit includes:

Step 101: Acquire data of ridership from an automatic fare collection (AFC) system, and determine a waiting time of passengers according to the ridership data. The waiting time includes a normal waiting time of normal passengers and a turn-back time of TB passengers. The normal waiting time is a time when normal passengers wait at a station for a train directly into a destination station. The turn-back time is the sum of an in-vehicle time when the TB passengers travel in an opposite direction and a waiting time of the TB passengers at an origin station and a turn-back station. Normal passengers are passengers who directly wait for a train to the destination station at the origin station. TB passengers are passengers who take a train in the opposite direction to the destination station and change their direction to the destination station at the turn-back station.

First, it is necessary to divide all origin-destination (OD) pairs in the metro network into single-route-non-transfer (SRNT) OD pairs, single-route-single-transfer (SRST) OD pairs and multi-route-multi-transfer (MRMT) OD pairs according to the number of feasible routes and transfer time in the OD route set of the metro network. The AFC data of passengers choosing SRNT OD routes are used to obtain the waiting time of passengers at a specified station on a specified line.

Step 102: Establish a passenger choice behavior model according to the waiting time of the passengers, where a passenger choice behavior includes normal travel and TB.

The passenger travel process is a two-stage choice behavior. In the first stage of choice, the passengers will decide whether to adopt a TB strategy (that is, whether to wait on the platform for a train heading directly to the destination or take a train in the opposite direction to the destination and then change the direction at the turn-back station). In the second stage of choice, the normal passengers will determine a train to board, and the TB passengers will determine a turn-back station. In the present disclosure, a Gaussian mixture model (GMM) is used to describe the first-stage choice behavior, and two GMMs are used to describe the second-stage choice behavior of normal passengers and TB passengers, respectively.

A GMM (see below) including two Gaussian distributions is used to describe the distribution of passenger waiting time, where one Gaussian distribution represents the waiting time distribution of normal passengers, and the other Gaussian distribution represents the turn-back time distribution of TB passengers.

$$p ( {t}_{r , o , d}^{W} ( z ) \vert {ω}_{r , o , d}^{0} , {μ}_{r , o , d}^{0} , {σ}_{r , o , d}^{0} , {ω}_{r , o , d}^{1} , {μ}_{r , o , d}^{1} , {σ}_{r , o , d}^{1} ) = {ω}_{r , o , d}^{0} \frac{1}{\sqrt{2 π} \cdot {σ}_{r , o , d}^{0}} {e}^{\frac{- {( {t}_{r , o , d}^{W} ( z ) - {μ}_{r , o , d}^{0} )}^{2}}{2 {σ}_{r , o , {d}^{2}}^{0}}} + {ω}_{r , o , d}^{1} \frac{1}{\sqrt{2 π} \cdot {σ}_{r , o , d}^{1}} {e}^{\frac{- {( {t}_{r , o , d}^{W} ( z ) - {μ}_{r , o , d}^{1} )}^{2}}{2 {σ}_{r , o , {d}^{2}}^{1}}}$$

In the equation, p(|) represents the probability density function of all waiting time (including both the waiting time of normal passengers and the turn-back time of TB passengers); t _{r,o,d}^{W}(z)represents the waiting time of passenger z, who chooses route r, at origin station o; μ_{r,o,d}⁰, σ_{r,o,d}⁰ and ω_{r,o,d}⁰ respectively represent the mean, standard deviation and weight vectors of the waiting time of normal passengers at origin station o; μ_{r,o,d}¹, σ_{r,o,d}¹ and ω_{r,o,d}¹ represent the mean, standard deviation and weight vectors of the turn-back time of TB passengers, respectively. When the waiting time of some normal passengers is not shorter than the turn-back time of TB passengers, the two Gaussian distributions will cross.

Step 102 may specifically include:

Establish the passenger choice behavior model according to the following equation:

$$p ( z ∈ NP \vert {t}_{r , o , d}^{W} ( z ) ) = \frac{{ω}_{r , o , d}^{0} \frac{1}{\sqrt{2 π} \cdot {σ}_{r , o , d}^{0}} {e}^{\frac{- {( {t}_{r , o , d}^{W} ( z ) - {μ}_{r , o , d}^{0} )}^{2}}{2 {σ}_{r , o , {d}^{2}}^{0}}}}{\begin{matrix}{ω}_{r , o , d}^{0} \frac{1}{\sqrt{2 π} \cdot {σ}_{r , o , d}^{0}} {e}^{\frac{- {( {t}_{r , o , d}^{W} ( z ) - {μ}_{r , o , d}^{0} )}^{2}}{2 {σ}_{r , o , {d}^{2}}^{0}}} + \\ {ω}_{r , o , d}^{1} \frac{1}{\sqrt{2 π} \cdot {σ}_{r , o , d}^{1}} {e}^{\frac{- {( {t}_{r , o , d}^{W} ( z ) - {μ}_{r , o , d}^{1} )}^{2}}{2 {σ}_{r , o , {d}^{2}}^{1}}}\end{matrix}}$$

$$p ( z ∈ T B P \vert {t}_{r , o , d}^{W} ( z ) ) = 1 - p ( z ∈ N P \vert {t}_{r , o , d}^{W} ( z ) )$$

In the equation, p(z∈NP|t_{r,o,d}^{W}(z)) represents the probability that passenger z is a normal passenger; p(z∈TBP|t_{r,o,d}^{W}(z)) represents the probability that passenger z is a TB passenger; NP represents the set of all normal passengers; TBP represents the set of all TB passengers; t_{r,o,d}^{W}(z) represents the waiting time of passenger z, who chooses route r, at origin station o; μ_{r,o,d}⁰, σ_{r,o,d}⁰ and ω_{r,o,d}⁰ respectively represent the mean, standard deviation and weight vectors of the normal waiting time of normal passengers, who choose route r, at origin station o; μ_{r,o,d}¹, σ_{r,o,d}¹ and ω_{r,o,d}¹ respectively represent the mean, standard deviation and weight vectors of the turn-back time of TB passengers, who choose route r, at origin station o.

Step 103: Acquire the maximum number of trains passengers have to wait for and the maximum number of turn-back stations.

Step 104: Establish a normal waiting time distribution model for normal passengers boarding different trains according to the maximum number of trains and the normal waiting time.

The two probabilities obtained in Step 102, p(z∈NP|t_{r,o,d}^{W}(z)) and p(z∈TBO|t_{r,o,d}^{W}(z)), divide all passengers into normal passengers and TB passengers. The normal passengers calibrate the parameters of the waiting time distribution model, and the TB passengers calibrate the parameters of the turn-back time distribution model.

The number of trains that normal passenger z has to wait for from origin station o to destination station d can be expressed as:

$$H ( z ) = \{ \begin{matrix}1 , 0 \leq {t}_{r , o , d}^{W} ( z ) < {t}_{{( F ( {A}_{r , o , d} ) )}^{τ} , {( F ( {A}_{r , o , d} ) )}^{0}}^{H} \\ 2 , {t}_{{( F ( {A}_{r , o , d} ) )}^{τ} , {( F ( {A}_{r , o , d} ) )}^{0}}^{H} \leq {t}_{r , o , d}^{W} ( z ) < 2 {t}_{{( F ( {A}_{r , o , d} ) )}^{τ} , {( F ( {A}_{r , o , d} ) )}^{0}}^{H} \\ … \\ \begin{matrix}{K}_{r , o , d}^{0} , ( {K}_{r , o , d}^{0} - 1 ) {t}_{{( F ( {A}_{r , o , d} ) )}^{τ} , {( F ( {A}_{r , o , d} ) )}^{0}}^{H} \leq \\ {t}_{r , o , d}^{W} ( z ) < {K}_{r , o , d}^{0} \cdot {t}_{{( F ( {A}_{r , o , d} ) )}^{τ} , {( F ( {A}_{r , o , d} ) )}^{0}}^{H}\end{matrix}\end{matrix} , \\ z ∈ {P}_{o , d} , z ∈ NP$$

In the equation, K_{r,o,d}⁰ represents the maximum number of trains that passengers need to wait; NP represents the set of all normal passengers; t_{(F(A}_{_{r,o,d}}₎₎_{^{π}}_{(F,A}_{_{r,o,d}}₎₎_{⁰} represents the headway of trains in the waiting direction of normal passengers whose origin station and destination station are o and d respectively; P_{o,d} represents the set of all passengers from origin station o to destination station d.

A GMM including K_{r,o,d}⁰ Gaussian distributions is used to describe the waiting time distribution of normal passengers taking different trains, as shown below. The function obtained here is a probability density function for the waiting time distribution of all normal passengers, which is used for the calibration of unknown parameters in Step 106. the contents of which are incorporated herein by reference

The normal waiting time distribution model is established according to the following equation:

$$p ( {t}_{r , o , d}^{W} ( z ) \vert {ω}_{r , o , d}^{0} , {μ}_{r , o , d}^{0} , {σ}_{r , o , d}^{0} ) = {\sum }_{i = 1}^{{K}_{r , o , d}^{0}} ( {ω}_{r , o , d}^{0 , i} \frac{1}{\sqrt{2 π} \cdot {σ}_{r , o , d}^{0 , i}} {e}^{\frac{- {( {t}_{r , o , d}^{W} ( z ) - {μ}_{r , o , d}^{0 , i} )}^{2}}{2 {σ}_{r , o , {d}^{2}}^{0 , i}}} )$$

In the equation, K_{r,o,d}⁰ represents the maximum number of trains that passenger z who chooses router needs to wait at origin station o; p(t_{r,o,d}^{W}(z)|ω_{r,o,d}^{0l ,μ}_{r,o,d}⁰,σ_{r,o,d}⁰) represents the probability density function for the distribution of all normal waiting time; ω_{r,o,d}⁰=(ω_{r,o,d}^{0,1},ω_{r,o,d}^{0.2}, . . . ω_{r,o,d}^{0,i}, . . . , ω_{r,o,d}^{0,K}^{_{r,o,d}}^{⁰}) represents a weight vector for the waiting time of normal passengers waiting for the i-th metro; μ_{r,o,d}⁰=(μ_{r,o,d}^{0,1},μ_{r,o,d}^{0,2}, . . . μ_{r,o,d}^{0,i}, . . . , μ_{r,o,d}^{0,K}^{_{r,o,d}}^{⁰}) and σ_{r,o,d}^{0,1},σ_{r,o,d}^{0,2}, . . . σ_{r,o,d}^{0,i}, . . . , σ_{r,o,d}^{0,K}^{_{r,o,d}}^{⁰}) respectively represent the mean vector and standard deviation vector of the normal waiting time of normal passengers waiting for the i-th metro.

Step 105: Establish a turn-back time distribution model for TB passengers choosing different turn-back stations according to the maximum number of turn-back stations and the turn-back time.

The turn-back stations chosen by TB passenger z¹ from o to d can be expressed as follows:

$$S ( {z}^{′} ) = \{ \begin{matrix}1 , 0 \leq {t}_{r , o , d}^{T B} ( {z}^{′} ) < {t}_{r , o , d , 1}^{T B} \\ 2 , {t}_{r , o , d , 1}^{T B} \leq {t}_{r , o , d}^{T B} ( {z}^{′} ) < {t}_{r , o , d , 2}^{T B} \\ … \\ {K}_{r , o , d}^{1} , {t}_{r , o , d ( {K}_{r , o , d}^{1} - 1 )}^{T B} \leq {t}_{r o , d}^{T B} ( {z}^{′} ) < {t}_{r , o , d {K}_{r , o , d}^{1}}^{T B}\end{matrix} {z}^{′} ∈ {P}_{o , d} , {z}^{′} ∈ TBP$$

In the equation, K_{r,o,d}¹ represents the maximum number of turn-back stations; TBP represents the set of all TB passengers; t_{r,o,d,i}^{TB} represents the turn-back time of TB passengers who change their direction at the i -th turn-back station.

A GMM including K_{r,o,d}¹ Gaussian distributions is used to describe the turn-back time distribution of TB passengers choosing different turn-back stations, as shown below. The function obtained here is a probability density function for the turn-back time distribution of all TB passengers, which is used for the calibration of unknown parameters in Step 106.

The turn-back time distribution model is established according to the following equation:

$$p ( {t}_{r , o , d , j}^{TB} ( z ) \vert {ω}_{r , o , d}^{1} , {μ}_{r , o , d}^{1} , {σ}_{r , o , d}^{1} ) = {\sum }_{j = 1}^{{K}_{r , o , d}^{1}} ( {ω}_{r , o , d}^{0 , i} \frac{1}{\sqrt{2 π} \cdot {σ}_{r , o , d}^{4 , i}} {e}^{\frac{- {( {t}_{r , o , d , j}^{TB} - {μ}_{r , o , d}^{1 , j} )}^{2}}{2 {σ}_{r , o , {d}^{2}}^{1 , j}}} )$$

In the equation, p(t_{r,o,d,j}^{TB}|ω_{r,o,d}¹,μ_{r,o,d}¹σ_{r,o,d}¹) represents the probability density function for the distribution of all turn-back time; K_{r,o,d}¹ represents the maximum number of turn-back stations; t_{r,o,d,j}^{TB} represents the average turn-back time of TB passengers between origin station o and turn-back station s_{r,o,d}^{j} on route r; ω_{r,o,d}¹=(ω_{r,o,d}^{1,1}, . . . , ω_{r,o,d}^{1,j}, . . . , ω_{r,o,d}^{1,K}^{_{r,o,d}}^{¹}) represents a weight vector for the turn-back time of TB passenger at the j-th turn-back station; μ_{r,o,d}¹=(μ_{r,o,d}^{1,1}, . . . , μ_{r,o,d}^{1,j}, . . . , μ_{r,o,d}^{1,K}^{_{r,o,d}}^{^{tb}}) and σ_{r,o,d}¹32 (σ_{r,o,d}^{1,1}, . . . σ_{r,o,d}^{1,j}, . . . , σ_{r,o,d}^{1,K}^{_{r,o,d}}^{¹}) represent the mean vector and standard deviation vector of the turn-back time of TB passengers at the j-th turn-back station, respectively.

Step 106: Calculate a joint posterior probability of parameters in the passenger choice behavior model, the normal waiting time distribution model and the turn-back time distribution model by using a Bayesian model to obtain the joint posterior probability of the parameters of each model.

The Bayesian model is used to calculate the joint posterior probability of the parameters in the passenger choice behavior model, to obtain the joint posterior probability of the parameters of the passenger choice behavior model. The Bayesian model is used to calculate the joint posterior probability of the parameters in the normal waiting time distribution model, to obtain the joint posterior probability of the parameters in the normal waiting time distribution model. The Bayesian model is used to calculate the joint posterior probability of the parameters in the turn-back time distribution model, to obtain the joint posterior probability of the parameters in the turn-back time distribution model.

The Bayesian model in Step 106 is a data-driven model, which is used to calculate the joint posterior probability of the parameters in the GMM. Specifically, the Bayesian model is used to calculate the joint posterior probability of the parameters in the GMM of the first-stage choice behavior and in the GMM of the choice behavior model, the joint posterior probability of the parameters μ_{r,o,d}⁰, σ_{r,o,d}⁰, ω_{r,o,d}⁰, μ_{r,o,d}¹, σ_{r,o,d}¹ and ω_{r,o,d}¹ is when the waiting time t_{r,o,d}^{W}(z) of passenger z is given. For the second-stage choice behavior model of normal passengers, the joint posterior probability of the parameters ω_{r,o,d}⁰, μ_{r,o,d}⁰ and σ_{r,o,d}⁰ is calculated when the waiting time t_{r,o,d}^{W}(z) of passenger z is given. For the second-stage choice behavior model of TB passengers, the joint posterior probability of the parameters μ_{r,o,d}¹, σ_{r,o,d}¹ and ω_{r,o,d}¹ is calculated when the waiting time t_{r,o,d,j}^{TB} of passenger z′ is given.

The Bayesian model is used to calculate the joint posterior probability of the parameters in the normal waiting time distribution model, to obtain the joint posterior probability of the parameters in the normal waiting time distribution model. This process may specifically include:

Take the normal waiting time as the observation data and the probability distribution function of the normal waiting time of normal passengers taking different trains as the likelihood function, and obtain the initial expression of the joint posterior probability of the parameters in the normal waiting time distribution model according to the Bayesian equation.

Take the probability distribution functions of the passenger waiting time WT_{r,o,d} and the waiting time of normal passengers taking different trains as observation data and the likelihood function respectively, and according to the Bayesian equation, obtain the initial expression of the joint posterior probability of the parameters as follows:

$$p ( {ω}_{r , o , d}^{0} , {μ}_{r , o , d}^{0} , {σ}_{r , o , d}^{0} \vert {WT}_{r , o , d} ) = \frac{p ( {WT}_{r , o , d} \vert {ω}_{r , o , d}^{0} , {μ}_{r , o , d}^{0} , {σ}_{r , o , d}^{0} ) p ( {ω}_{r , o , d}^{0} , {μ}_{r , o , d}^{0} , {σ}_{r , o , d}^{0} )}{p ( {WT}_{r , o , d} )} ∝ p ( {WT}_{r , o , d} \vert {ω}_{r , o , d}^{0} , {μ}_{r , o , d}^{0} , {σ}_{r , o , d}^{0} ) p ( {ω}_{r , o , d}^{0} , {μ}_{r , o , d}^{0} , {σ}_{r , o , d}^{0} )$$

In the equation, p(ω_{r,o,d}⁰,μ_{r,o,d}⁰,σ_{r,o,d}⁰) is the joint prior probability function of ω_{r,o,d}⁰, μ_{r,o,d}⁰ and σ_{r,o,d}⁰; p(WT_{r,o,d}|ω_{r,o,d}⁰,σ_{r,o,d}⁰) is the likelihood function of the given parameters ω_{r,o,d}⁰, μ_{r,o,d}⁰ and σ_{r,o,d}⁰ and the observation data WT_{r,o,d}.

Determine the joint prior probability function of the parameters according to the mean, standard deviation and weight vectors of the normal waiting time of normal passengers waiting for the i-th metro.

The probability p(WT_{r,o,d}) of the observation data is fixed. Assuming that the mean μ_{r,o,d}^{0,i} and standard deviation σ_{r,o,d}^{0,i} follow the Gaussian distribution, and the weight parameter ω_{r,o,d}⁰ is a vector that follows the Dirichlet distribution of

$$\text{?} {ω}_{r , o , d}^{0 , i} = 1 , \\ \text{?} \text{indicates text missing or illegible when filed}$$

then:

$${μ}_{r , o , d}^{0 , i} • Gaussian ( {δ}_{r , o , d}^{0 , i} , {v}_{r , o , d}^{0 , i} )$$

$${σ}_{r , o , d}^{0 , i} • Gaussian ( {κ}_{r , o , d}^{0 , i} , {γ}_{r , o , d}^{0 , i} )$$

$${ω}_{r , o , d}^{0} • Dirichlet ( {ω}_{r , o , d}^{0 , 1} , {ω}_{r , o , d}^{0 , 2} , … , {ω}_{r , o , d}^{0 , {K}_{r , o , d}^{0}} )$$

In the equation, δ_{r,o,d}^{0,i}, ν_{r,o,d}^{0,i}, κ_{r,o,d}^{0,i}, γ_{r,o,d}^{0,i} and (i=1,2, . . . , K_{r,o,d}⁰) are hyperparameters, and the joint prior probability function of the parameters can be expressed as:

$$p ( {ω}_{r , o , d}^{0} , {μ}_{r , o , d}^{0} , {σ}_{r , o , d}^{0} ) = p ( {ω}_{r , o , d}^{0} ) p ( {μ}_{r , o , d}^{0} ) p ( {σ}_{r , o , d}^{0} ) = p ( {ω}_{r , o , d}^{0 , 1} , {ω}_{r , o , d}^{0 , 2} , … , {ω}_{r , o , d}^{0 , {K}_{r , o , d}^{0}} ) [ {\prod }_{i = 1}^{{K}_{r , o , d}^{0}} p ( {μ}_{r , o , d}^{0 , i} \vert {δ}_{r , o , d}^{0 , i} , {v}_{r , o , d}^{0 , i} ) p ( {δ}_{r , o , d}^{0 , i} , {v}_{r , o , d}^{0 , i} ) ] \cdot [ {\prod }_{i = 1}^{{K}_{r , o , d}^{0}} p ( {σ}_{r , o , d}^{0 , i} \vert {κ}_{r , o , d}^{0 , i} , {γ}_{r , o , d}^{0 , i} ) p ( {κ}_{r , o , d}^{0 , i} , {γ}_{r , o , d}^{0 , i} ) ]$$

Calculate the probability of passenger waiting time according to the mean, standard deviation and weight vectors of the normal waiting time of normal passengers, who choose route r, at origin station o.

Use the observation data t_{r,o,d}^{W}(z) to optimize the likelihood function based on the Bayesian theory, and calculate the probability of WT_{r,o,d} according to the given ω_{r,o,d}⁰, μ_{r,o,d}⁰ and σ_{r,o,d}⁰:

$$p ( {WT}_{r , o , d} \vert {ω}_{r , o , d}^{0} , {μ}_{r , o , d}^{0} , {σ}_{r , o , d}^{0} ) = {\sum }_{i = 1}^{{K}_{r , o , d}^{0}} p ( {WT}_{r , o , d} \vert {ω}_{r , o , d}^{0 , i} , {μ}_{r , o , d}^{0 , i} , {σ}_{r , o , d}^{0 , i} ) p ( {ω}_{r , o , d}^{0 , i} , {μ}_{r , o , d}^{0 , i} , {σ}_{r , o , d}^{0 , i} )$$

In the equation, p(ω_{r,o,d}^{0,i},μ_{r,o,d}^{0,i},σ_{r,o,d}^{0,i}) is the posterior probability density function of ω_{r,o,d}^{0,i}, μ_{r,o,d}^{0,i} and σ_{r,o,d}^{0,i} corresponding to the given i .

Determine the likelihood function of the observation data based on the observation data.

The passenger waiting time WT_{r,o,d} is composed of an independent element, t_{r,o,d}^{W}(z), that is, the travel time of each passenger is independent. Therefore, the probability of WT_{r,o,d} can be expressed as the joint probability of all waiting time observation data. In other words, the likelihood function of WT_{r,o,d} can be expressed as the product of the probabilities of each element t_{r,o,d}^{W}(z)∈WT_{r,o,d},z∈P_{o,d}, as follows:

$$p ( {WT}_{r , o , d} \vert {ω}_{r , o , d}^{0} , {μ}_{r , o , d}^{0} , {σ}_{r , o , d}^{0} ) = {\prod }_{{t}_{r , o , d}^{W} ( z ) ∈ {WT}_{r , o , d}} p ( {t}_{r , o , d}^{W} \vert {ω}_{r , o , d}^{0} , {μ}_{r , o , d}^{0} , {σ}_{r , o , d}^{0} ) = {\prod }_{{t}_{r , o , d}^{W} ( z ) ∈ {WT}_{r , o , d}} [ {\sum }_{i = 1}^{{K}_{r , o , d}^{0}} p ( {t}_{r , o , d}^{W} ( z ) \vert {ω}_{r , o , d}^{0 , i} , {μ}_{r , o , d}^{0 , i} , {σ}_{r , o , d}^{0 , i} ) p ( {ω}_{r , o , d}^{0 , i} , {μ}_{r , o , d}^{0 , i} , {σ}_{r , o , d}^{0 , i} ) ]$$

Determine the actual joint posterior probability of the parameters according to the initial expression of the joint posterior probability of the parameters of the normal waiting time distribution model, the joint prior probability function, the probability of the normal waiting time of passengers and the likelihood function of the observation data.

Integrate the above equations to obtain the expression (see below) of the joint posterior probability of the final parameters, and use this expression combined with the observation data from the AFC system to calculate the parameters ω_{r,o,d}⁰, μ_{r,o,d}⁰ and σ_{r,o,d}⁰ in the hybrid model describing the passenger behavior.

$$p ( {ω}_{r , o , d}^{0} , {μ}_{r , o , d}^{0} , {σ}_{r , o , d}^{0} \vert {WT}_{r , o , d} ) ∝ \begin{matrix}{\prod }_{{t}_{r , o , d}^{W} ( z ) ∈ {WT}_{r , o , d}} [ {\sum }_{i = 1}^{{K}_{r , o , d}^{0}} p ( {t}_{r , o , d}^{W} ( z ) \vert {ω}_{r , o , d}^{0 , i} , {μ}_{r , o , d}^{0 , i} , {σ}_{r , o , d}^{0 , i} ) p ( {ω}_{r , o , d}^{0 , i} , {μ}_{r , o , d}^{0 , i} , {σ}_{r , o , d}^{0 , i} ) ] \cdot \end{matrix} \begin{matrix}p ( {ω}_{r , o , d}^{0 , 1} , {ω}_{r , o , d}^{0 , 2} , … , {ω}_{r , o , d}^{0 , {K}_{r , o , d}^{0}} ) [ {\prod }_{i = 1}^{{K}_{r , o , d}^{0}} p ( {μ}_{r , o , d}^{0 , i} \vert {δ}_{r , o , d}^{0 , i} , {v}_{r , o , d}^{0 , i} ) p ( {δ}_{r , o , d}^{0 , i} , {v}_{r , o , d}^{0 , i} ) ] \cdot \end{matrix} \begin{matrix}[ {\prod }_{i = 1}^{{K}_{r , o , d}^{0}} p ( {σ}_{r , o , d}^{0 , i} \vert {κ}_{r , o , d}^{0 , i} , {γ}_{r , o , d}^{0 , i} ) p ( {κ}_{r , o , d}^{0 , i} , {γ}_{r , o , d}^{0 , i} ) ]\end{matrix}$$

The Bayesian model is used to calculate the joint posterior probability of the parameters in the passenger choice behavior model, to obtain the joint posterior probability of the parameters of the passenger choice behavior model. This process may specifically include:

Use the passenger waiting time (including normal waiting time and turn-back time) as the observation data and the distribution function of the waiting time of passengers taking different trains as the likelihood function, and obtain the initial expression of the joint posterior probability of the parameters in the passenger choice behavior model according to the Bayesian equation.

Determine the joint prior probability function of the parameters according to the mean, standard deviation and weight vectors of the waiting time of passengers waiting for the i-th metro.

Calculate the probability of the passenger waiting time according to the mean, standard deviation and weight vectors of the waiting time of passengers, who choose route r, at origin station o.

Determine the likelihood function of the observation data based on the observation data.

Determine the probability of the parameters in the actual passenger choice behavior model according to the initial expression of the joint posterior probability, the joint prior probability function, the probability of the passenger waiting time and the likelihood function of the observation data.

The Bayesian model is used to calculate the joint posterior probability of the parameters in the turn-back time distribution model, to obtain the joint posterior probability of the parameters in the turn-back time distribution model. This process may specifically include:

Use the turn-back time as the observation data and the probability distribution function of the turn-back time of TB passengers at different turn-back stations as the likelihood function, and obtain the initial expression of the joint posterior probability of the parameters in the normal waiting time distribution model according to the Bayesian equation.

Determine the joint prior probability function of the parameters according to the mean, standard deviation and weight vectors of the turn-back time of TB passengers at the j-th turn-back station.

Calculate the probability of the turn-back time of passengers according to the mean, standard deviation and weight vectors of the turn-back time of TB passengers, who choose route r, at origin station o.

Determine the likelihood function of the observation data based on the observation data.

Determine the probability of the actual parameters according to the initial expression of the joint posterior probability, the joint prior probability function, the probability of the turn-back time and the likelihood function of the observation data.

Step 107: Use a no-u-turn sampler (NUTS) algorithm to estimate the parameters in each joint posterior probability to obtain estimated parameters.

The NUTS algorithm is used to estimate parameters in the joint posterior probability of the parameters in the passenger choice behavior model, the joint posterior probability of the parameters in the normal waiting time distribution model and the joint posterior probability of the parameters in the turn-back time distribution model, to obtain a first estimated parameter value, a second estimated parameter value and a third estimated parameter value.

The NUTS algorithm needs to estimate parameters in the Bayesian model. Specifically, it needs to estimate 3K_{r,o,d}⁰ parameters, that is, ω_{r,o,d}^{0,i}, μ_{r,o,d}^{0,i} and σ_{r,o,d}^{0,i}, i=1,2, . . . , K_{r,o,d}⁰. The NUTS algorithm includes the following sub-steps:

1) Given K_{r,o,d}⁰, the K-means clustering method is used to initialize the prior distribution of the parameters, that is, to determine the values of the hyperparameters. In clustering, the input parameter K is set to K_{r,o,d}⁰, and the mean, deviation and proportion of the data in the i-th (i=1,2, . . . , K_{r,o,d}⁰) cluster in the clustering result are calculated as the values of the hyperparameters. Let t=1, so the initial parameters can be denoted as x₍₀₎={x₍₀₎¹,x₀₎², . . . , x₍₀₎^{3K}^{_{r,o,d}}^{⁰}}, which represent the mean, standard deviation and weight vectors of the three GMMs.

2) Sample r_{9T0}^{□N(0,I)},where I is an identity matrix; N(α,Σ) represents a multivariate Gaussian distribution represented by mean α and covariance matrix Σ; r, x, I have the same dimensions. This initial sample represents the error value of the parameter to be calibrated and has no realistic physical meaning.

3) Apply the existing NUTS algorithm:

Construct the Hamiltonian function, H(x,r)=U(x₍ₜ₎)+K(r(₍ₜ₎), where U(x₍ₜ₎),K(r₍ₜ₎) represent potential energy and kinetic energy functions, respectively. U (x₍ₜ₎)=−log [π(x₍ₜ₎)L(x₍ₜ₎|D)], K(r₍ₜ₎)=½r₍ₜ₎^{T}M⁻¹r₍ₜ₎, where π(x₍ₜ₎) is the prior distribution; L(x₍ₜ₎|D) is the likelihood function of the given data D; M is a symmetric, positive-definite and diagonal matrix. The Hamiltonian function is an inference framework used to calibrate

$${x}_{( 0 )} = \{ {x}_{( 0 )}^{1} , {x}_{( 0 )}^{2} , … , {x}_{( 0 )}^{3 {K}_{r , o , d}^{0}} \} .$$

Build a node tree composed of Q subtrees via a recursive procedure, where the q-th subtree is built with 2q nodes. The process of building the node tree will be terminated if the trajectory of nodes begins to recede.

Sample u□U(0,1), where U(a,b) denotes a uniform distribution with lower bound a and upper bound b, and calculate the probability that nodes in the q-th subtree are selected as the state of the next iteration:

$$\frac{{\sum }_{q = 1}^{{2}^{q}} • ( u \leq exp \{ - H ( {x}_{( h )} , {r}_{( h )} ) \} )}{{\sum }_{q = 1}^{Q} {\sum }_{h = 1}^{{2}^{q}} • ( u \leq exp \{ - H ( {x}_{( h )} , {r}_{( h )} ) \} )}$$

where □(·) is 1 if the expression in the brackets is true and 0 if it is false; calculate the probability that the k-th node in the q-th subtree is selected.

$$\frac{• ( u \leq exp \{ - H ( {x}_{( k )} , {r}_{( k )} ) \} )}{{\sum }_{h = 1}^{k} • ( u \leq exp \{ - H ( {x}_{( h )} , {r}_{( h )} ) \} )}$$

Then, select node x* with the highest probability as the state of the next iteration, namely, set x_{(t)=x*.}

4) Determine whether the current iteration number t is equal to the maximum iteration number C; if so, proceed to Step 5.5; otherwise, set t=t+1 and return to Step 5.2.

5) Record the values of all parameters. The final value of each parameter is given as follows:

$$x = \frac{1}{C - N} {\sum }_{t = N + 1}^{C} {x}_{( t )}^{i}$$

Step 108: Identify TB passengers, turn-back stations and boarding trains of TB passengers and boarding trains of normal passengers according to the estimated parameters to obtain an identification result.

Step 109: Calculate the waiting time at each station and a loading rate in each running section according to the identification result.

A case study of a suburban line of the Beijing metro was conducted, where Shahe station and Shahe University Park station were taken as TB stations to investigate passenger TB behaviors. All AFC data and train timetables of the two stations during the morning peak hours (7:00-9:00 AM) on weekdays in September 2018 were collected. Based on the collected data, the travel time of the passengers is calculated, and valid data are extracted (that is, the too long or too short travel time is ignored). The calculation is as follows:

t_{o,d}(z)=t_{d}^{Out}(z),z∈P_{o,d}

In the equation, tₒ^{In}(z) represents the arrival timestamp of passenger z at origin station o, and t_{d}^{Out}(z) represents the departure timestamp of passenger z at destination station d. P_{o,d} represents the set of all passengers from origin station o to destination station d.

Specifically, the travel data of passengers on all OD pairs with origin station o are selected. The OD pairs are ranked according to the number of trips, and the top 100 OD pairs with the maximum number of trips are studied.

Further, the 100 OD pairs are classified based on the number of feasible routes and transfer time in the feasible route set.

(1) SRNT OD: One feasible normal route without transfer.

(2) SRMT OD: One feasible normal route with one transfer.

(3) MRMT OD: More than one feasible route and more than one transfer.

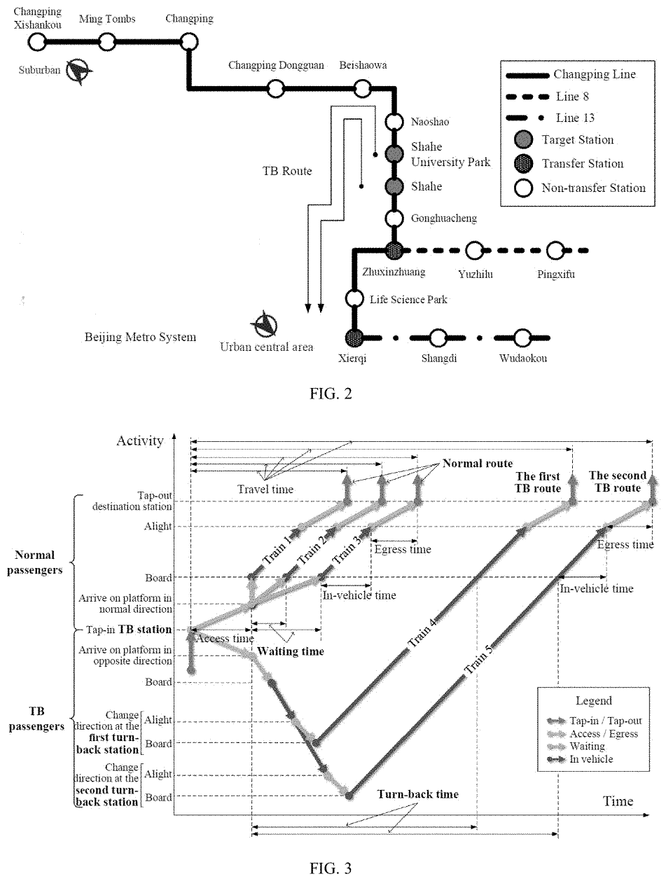

Further, the SRNT OD pairs to be analyzed are the OD pairs with Zhuxinzhuang, Life Science Park and Xierqi stations as the destination station respectively, as shown in FIG. 2. The destination stations are in the direction of “suburban-urban central area” on the same metro line, as shown in FIG. 2.

With the shortest travel time as the benchmark (i.e. a waiting time of zero), the waiting time of a normal passenger is his actual waiting time at the platform. The waiting time of a TB passenger is his turn-back time, including the in-vehicle time and the waiting time at the TB station and the turn-back station. FIG. 3 shows the illustration of the space-time process of passenger travel in a metro network.

Further, the turn-back time of the TB passengers is calculated as follows:

$${t}_{r , o , d , j}^{T B} = {t}_{r , o , {s}_{r , o , d}^{j}}^{I} ( z ) + {t}_{r , {s}_{r , o , d}^{i} , o}^{I} ( z ) + \frac{h w}{2} + \frac{o h w}{2} , {ψ}_{r , o , d} = 1 , z ∈ T B P$$

$$hw = {t}_{{a}^{τ} , {a}^{0}}^{H} , a = F ( {A}_{r , o , d} )$$

ohw=t_{(a′)}_{^{τ}}_{,(a′)}_{⁰}, ∀a′∈A_{r,o,d},(a′)⁻=(F(A_{r,o,d}))⁺,(a′)⁺=o,(a′)^{τ}=(F(A_{r,o,d}))^{τ}

In the equation, t_{r,o,d,j}^{TB} represents the average turn-back time between origin station o and j-th-nearest turn-back station s_{r,o,d}^{j}; t_{r,o,d}^{W}(z) represents the in-vehicle time of passenger z on route r from origin station o to destination station d; t_{t,dir}^{H} represents the average headway of trains on line 1 with direction dir; A_{r,o,d} represents the set of running sections in sequence on route r from origin station o to destination station d; a⁻,a⁺ represent the head station and the tail station of running section a respectively; F(X) represents the first element in set X.

Further, the in-vehicle time is calculated as follows:

$${t}_{s , l , dir}^{D} = {\sum }_{h ∈ {H}_{a}} ( {t}_{s , l , dir}^{D} ( h ) - {t}_{s , l , dir}^{A} ( h ) ) / \vert {H}_{a} \vert , ∀ l ∈ L , s ∈ {S}_{t , o , d} , a ∈ A , {a}^{+} = s , {a}^{τ} = l , {a}^{0} = dir$$

$${t}_{a}^{R} ( h ) = {t}_{{a}^{+} , {p}^{τ} , {a}^{0}}^{A} ( h ) - {t}_{{a}^{- ,} {a}^{τ} , {a}^{0}}^{D} ( h ) , h ∈ {H}_{a}$$

$${t}_{r , o , d}^{I} = {\sum }_{a ∈ {A}_{r , o , d}} {\sum }_{h ∈ {H}_{a}} {t}_{a}^{R} ( h ) / \vert {H}_{a} \vert + {\sum }_{a ∈ {A}_{r , o , d} ∖ F ( {A}_{r , o , d} )} {t}_{{a}^{-} , {a}^{τ} , {a}^{0}}^{D}$$

In the equation, t_{s,t,dir}^{D} represents the average dwell time of trains at station s on line 1 with direction dir; t_{s,1,dir}^{D}(h) and 6_{s,1,dir}^{A}(h) respectively represent the departure timestamp and the arrival timestamp of train h at station s in line 1 with direction dir; Ha represents the set of trains on running section a; L represents the set of all lines; S_{r,o,d} represents the set of stations in sequence on route r from origin station o to destination station d; A represents the set of all running sections; tₐ^{R}(h) represents the running time of train h in running section a.

Further, the average headway is calculated as follows:

$${t}_{l , dir}^{H} = {\sum }_{h ∈ {H}_{a}} ( {t}_{s , l , dir}^{A} ( h + 1 ) - {t}_{s , l , dir}^{A} ( h ) ) / \vert {H}_{a} \vert , ∀ l ∈ L , s ∈ {S}_{r , o , d} , a ∈ A , {a}^{+} = s , {a}^{τ} = l , {a}^{0} = dir$$

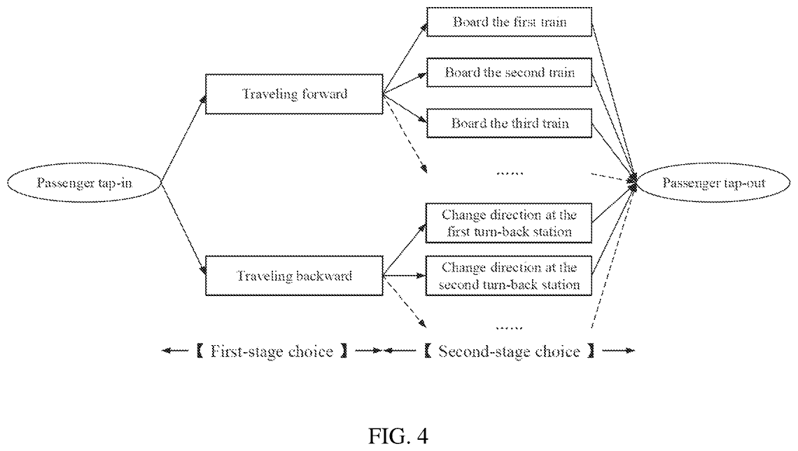

Based on the waiting time data of passengers, the Gaussian mixture models are used to describe the two-stage choice behavior of passengers (FIG. 4). Further, a dual-Gaussian mixture distribution model is used to simulate the passenger's first-stage choice behavior (i.e. the joint distribution of the waiting time of normal passengers and TB passengers). A multi-Gaussian mixture distribution model is used to simulate the distribution of the waiting time of normal passengers in the second stage (i.e. the joint distribution of the waiting time of normal passengers choosing different trains). A multi-Gaussian mixture distribution model is used to simulate the distribution of the turn-back time of TB passengers in the second stage (i.e. the joint distribution of the turn-back time of TB passengers choosing different turn-back stations). Thus, three different Gaussian mixture distributions are obtained.

By introducing the Bayesian model, the parameters in the three Gaussian mixture distributions (i.e. mean, standard deviation and weight) are calibrated. The Bayesian model calculates the posterior probability distribution function of the parameters by combining the prior probability function of the parameters and the observation data (i.e. waiting time) to perform preliminary calibration on the parameters.

Based on the posterior probability distribution function of the parameters obtained by using the Bayesian model, the parameters are finally calibrated by the NUTS algorithm (that is, the parameter values are obtained). The K-means clustering method is used to initialize the prior distribution of the parameters, then the Hamiltonian function is constructed, and the node tree is constructed via a recursive procedure for iteration. The maximum iteration number is set to 15,000 and the burn-in iteration number is set to 9,000 (that is, the sampling results of the previous 9,000 generations are considered unstable and are discarded, and the stable sampling values of the next 6,000 generations are used to estimate the posterior distribution function of the parameters). After reaching the maximum iteration number, the final value of each parameter is obtained.

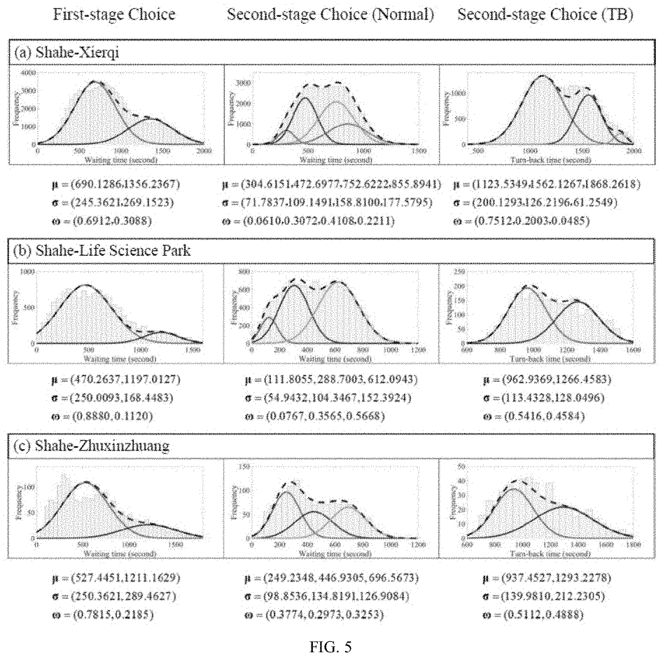

As shown in FIG. 5, in the left subplots (first-stage choice) of FIG. 5, (1) shows the waiting time distribution of normal passengers, (2) shows the turn-back time distribution of TB passengers, and the dotted line shows the joint probability distribution. In the middle subplots (first-stage choice, normal), (3) shows the distribution of the waiting time for the first train, (4) shows the distribution of the waiting time for the second train, (5) shows the distribution of the waiting time for the third train, (6) shows the distribution of the waiting time for the fourth train, and the dotted line shows the joint probability distribution. In the right subplots (second-stage choice, TB), (7) shows the distribution of the turn-back time at the first turn-back station, (8) shows the distribution of the turn-back time at the second turn-back station, (9) shows the distribution of the turn-back time at the third turn-back station, and the dotted line shows the joint probability distribution. In FIG. 5, the abscissas in the left and middle subplots represent waiting time(s); the abscissas in the right subplots represent turn-back time(s); the ordinates in each subplot of FIG. 5 all indicate frequency, which is the number of times that the waiting time or the turn-back time occurs.

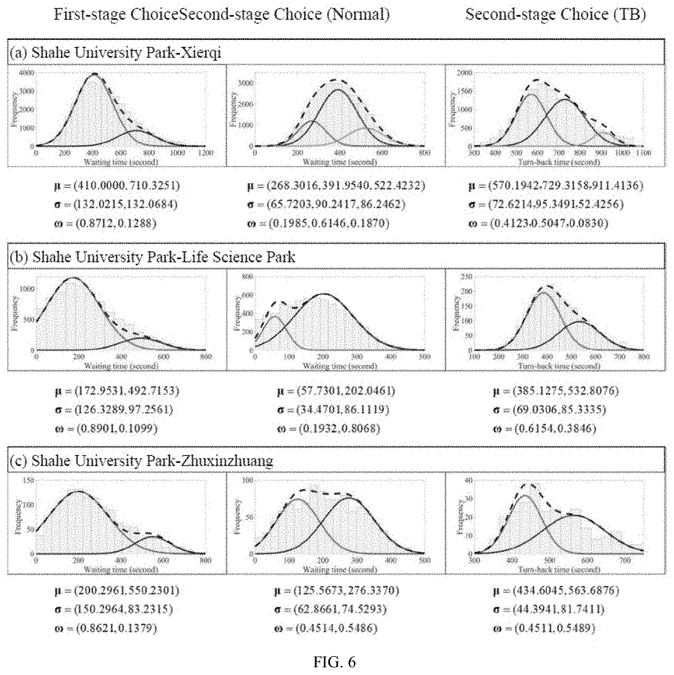

As shown in FIG. 6, in the left subplots (first-stage choice) of FIG. 6, (1) shows the waiting time distribution of normal passengers, (2) shows the turn-back time distribution of TB passengers, and the dotted line shows the joint probability distribution. In the middle subplots (first-stage choice, normal), (3) shows the distribution of the waiting time for the first train, (4) shows the distribution of the waiting time for the second train, (5) shows the distribution of the waiting time for the third train, and the dotted line shows the joint probability distribution. In the right subplots (second-stage choice, TB), (6) shows the distribution of the turn-back time at the first turn-back station, (7) shows the distribution of the turn-back time at the second turn-back station, (8) shows the distribution of the turn-back time at the third turn-back station, and the dotted line shows the joint probability distribution. In FIG. 6, the abscissas in the left and middle subplots represent waiting time(s); the abscissas in the right subplots represent turn-back time(s); the ordinates in each subplot in FIG. 6 all indicate frequency.

The calibration results of the parameters in FIGS. 5 and 6 show that:

(1) The parameter calibration results of the first-stage passenger choice model for the destination station Xierqi are shown on the left of FIG. 5. μ=(690.1286,1356.2367) and ω=(0.6912,0.3088) indicate and indicate that the average waiting time for normal passengers (accounting for 69.12%) is approximately 690 s, and the average turn-back time of TB passengers (accounting for 30.88%) is approximately 1356 s. The model parameter calibration results of normal passengers and TB passengers in the second stage are shown in the middle and right subplots of FIG. 5. The results demonstrate that normal passengers have to wait for up to four trains and 71.80% (i.e., 0.3071+0.4108) of them board the second or third train; by contrast, 75.12% of TB passengers change their direction at the first turn-back station.

(2) The TB phenomena of the two other destination stations (Life Science Park and Zhuxinzhuang) are analyzed in a similar manner, and the results are shown in the middle and lower subplots of FIG. 5. For OD pairs whose destination station is not on Changping Line, as shown in FIG. 2, the TB characteristics of the corresponding transfer station (Zhuxinzhuang or Xierqi) are considered instead. For example, passengers from Shahe to Wudaokou (a station on Line 13 in FIG. 2) often transfer from Changping Line to Line 13 at the transfer station Xierqi. Thus, the TB characteristics of the OD pair Shahe-Wudaokou are replaced by those of the Shahe-Xierqi pair, that is, 30.88% of passengers adopt the TB strategy, and 75.12% of TB passengers change their direction at the first turn-back station. For the top 100 OD pairs for which the origin station is Shahe, the corresponding TB characteristics are obtained via the above-mentioned methods. Finally, the TB phenomenon at Shahe station is analyzed by summarizing the TB characteristics of each OD pair.

(3) Similarly, the TB phenomena at Shahe University Park station are analyzed. For the OD pairs with a destination station in the direction of “suburban-urban central area” on the Changping Line, the calculation results are plotted in FIG. 6. For example, the weight vector of the OD pair Shahe University Park-Xierqi is: ω=(0.8712,0.1288) which means that the proportion of TB passengers in this OD pair (12.88%) is less than that in the Shahe-Xierqi OD pair (30.88%). This finding indicates that a farther travel distance leads to a stronger TB behavioral intention. In the right subplots of FIGS. 5 and 6, a TB passenger chooses one of the first three nearest stations to the origin station as the turn-back station, and most TB passengers change their travel direction at the first turn-back station, thus avoiding congestion and leading to a limited increase in the travel time.

The TB phenomenon changes the distribution of passenger flow in the metro network. The TB model proposed in the present disclosure can be used to correct the passenger flow distribution. To demonstrate the effectiveness of the proposed TB model, the model is compared with a demand assignment model based on the maximum likelihood estimation (MLE) method. The MLE-based demand assignment model considers the left behind (LB) phenomenon of passengers (a large number of passengers fail to board the first arriving train because of its high load), but ignores the TB phenomenon of passengers. The train loading rates in the direction of “suburban-urban central area” on the Changping Line during morning rush hours are obtained by the two assignment models. Specifically, the loading rates (representing passenger flow distribution on the line) of many trains in the sections of Shahe-Gonghuacheng and Gonghuacheng-Zhuxinzhuang are over 130% according to the MLE-based demand assignment model, which means that more than 7 persons are standing per square meter in the train, which is nearly impossible in reality. By contrast, most train loading rates in the crowded sections are between 80% and 120% in the proposed TB model. Thus, the proposed TB model contributes more in accurately estimating the actual train loading rates and better describing the passenger travel process than the existing MLE-based demand assignment model.

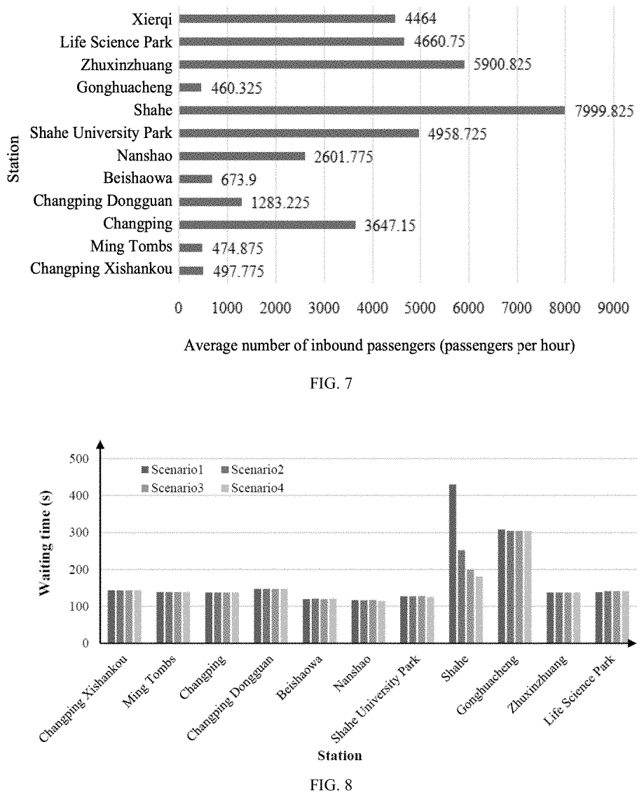

Taking the Changping Line as an example, as shown in FIG. 7, a serious imbalance is observed in the numbers of inbound passengers at different stations on this line. Shahe station with the largest number of passengers is chosen as the target station, and four passenger flow control scenarios are formulated, as follows:

(1) No passenger flow control.

(2) Control 20% of inbound passengers at Shahe station.

(3) Only control normal passengers with the same control volume with Scenario (2).

(4) Control normal passengers of Shahe station and TB passengers of Shahe University Park or Nanshao station, with the same total volume as Scenario (2).

Specifically, the waiting time of passengers at platforms and the number of LB passengers are calculated using the existing passenger flow control model (Xu et al.) to evaluate the effectiveness of the four control scenarios.

The waiting time of passengers at different stations is illustrated in FIG. 8. The four passenger flow control scenarios shorten the average waiting time of passengers to different degrees. For example, the waiting time at Shahe station in the four scenarios are 429.82, 251.91, 199.06, and 180.68 s, respectively. Therefore, the passenger flow control measures are necessary to reduce the time of passengers wasted at the platform. A comparison of the results in Scenarios 2 and 3 concludes that controlling the normal passengers shows better performance than controlling the total inbound passengers with the same control volume. In Scenarios 3 and 4, the waiting time of passengers in Nanshao, Shahe University Park and Shahe station are 117.55 s/114.71 s, 127.95 s/125.14 s, and 199.06 s/180.68 s, respectively. The above-mentioned results show that simultaneously controlling passengers at the target station (Shahe station) and its turn-back stations (i.e. Nanshao and Shahe University Park) performs better than merely controlling passengers at the target station.

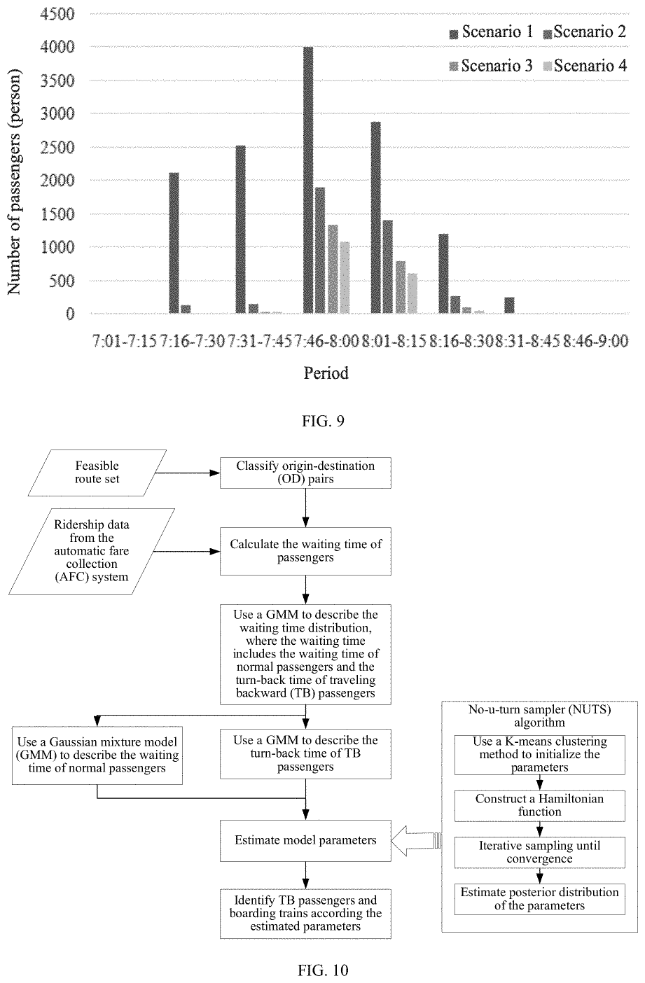

Further, FIG. 9 illustrates the number of LB passengers on the Changping Line during the morning rush hours. It can be observed that the number of passengers LB in Scenario 4 is the minimal number. For example, in the most crowded period of 7:46-8:00, the numbers of LB passengers in these scenarios are 3998, 1892, 1330, and 1086, respectively. Correspondingly, the latter three control strategies in Scenario 2, Scenario 3 and Scenario 4 reduce the number of LB passengers by 52.68%, 66.73%, and 72.84%, respectively.

The method proposed in the present disclosure can be used to analyze the issue of TB passengers and their routing in the crowded metro. Moreover, by considering the TB phenomenon, accurate passenger flow distribution can be obtained. The TB behavior is the basis of state estimation, passenger flow control and timetable optimization. In practice, the method proposed in the present disclosure can assist metro managers to efficiently control passenger flow at crowded stations and turn-back stations from a network view. In the future, mobile signaling data will be incorporated to accurately obtain passenger tracks in the metro system, and the waiting time and turn-back time of passengers can be easily determined. The mobile signaling data will be a powerful tool to further study the motivation and influencing factors of TB behavior.

FIG. 10 shows a flowchart of the method proposed by the present disclosure. The method includes: obtain the waiting time of passengers at specified stations and in the specified running directions in the rail transit network; identify normal passengers and TB passengers on the SRNT OD pairs based on the waiting time of passengers; further identify the boarding trains chosen by normal passengers and the turn-back stations and boarding trains chosen by TB passengers; and finally obtain the TB passengers, boarding trains and TB routes on all the OD pairs in the entire metro network. By subdividing the types of passengers in the crowded rail transit, the method and system of the present disclosure accurately estimate the waiting time at each busy station and the loading rate in the various running sections, which provides a more accurate and reasonable basis for passenger flow control and transport capacity allocation.

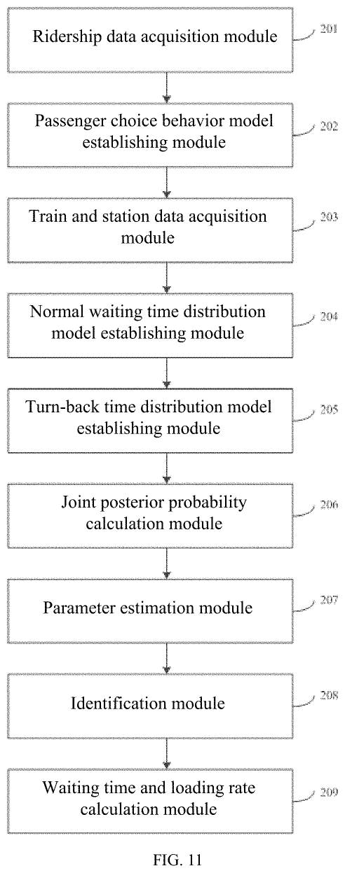

FIG. 11 is a structural diagram of a system for identifying TB passengers and boarding trains in rail transit according to an embodiment of the present disclosure. As shown in FIG. 11, the system for identifying TB passengers and boarding trains in rail transit includes a ridership data acquisition module, a passenger choice behavior model establishing module, a train and station data acquisition module, a normal waiting time distribution model establishing module, a turn-back time distribution model establishing module, a joint posterior probability calculation module, a parameter estimation module, an identification module and a waiting time and loading rate calculation module.

The ridership data acquisition module 201 is configured to acquire data of ridership from an AFC system, and determine a waiting time of passengers according to the ridership data, where the waiting time includes a normal waiting time of normal passengers and a turn-back time of TB passengers; the normal waiting time is a time when the normal passengers wait at a station for a train directly into a destination station; the turn-back time is the sum of an in-vehicle time when the TB passengers travel in an opposite direction and a waiting time of the TB passengers at an origin station and a turn-back station.

The passenger choice behavior model establishing module 202 is configured to establish a passenger choice behavior model according to the waiting time of the passengers, where a passenger choice behavior includes normal travel and TB.

The passenger choice behavior model establishing module 202 specifically includes a passenger choice behavior model establishing unit.

The passenger choice behavior model establishing unit is configured to establish a passenger choice behavior model according to the following equation:

$$p ( z ∈ NP \vert {t}_{r , o , d}^{W} ( z ) ) = \frac{{ω}_{r , o , d}^{0} \frac{1}{\sqrt{2 π} \cdot {σ}_{r , o , d}^{0}} {e}^{\frac{- {( {t}_{r , o , d}^{W} ( z ) - {μ}_{r , o , d}^{0} )}^{2}}{2 {σ}_{r , o , {d}^{2}}^{0}}}}{\begin{matrix}{ω}_{r , o , d}^{0} \frac{1}{\sqrt{2 π} \cdot {σ}_{r , o , d}^{0}} {e}^{\frac{- {( {t}_{r , o , d}^{W} ( z ) - {μ}_{r , o , d}^{0} )}^{2}}{2 {σ}_{r , o , {d}^{2}}^{0}}} + \\ {ω}_{r , o , d}^{1} \frac{1}{\sqrt{2 π} \cdot {σ}_{r , o , d}^{1}} {e}^{\frac{- {( {t}_{r , o , d}^{W} ( z ) - {μ}_{r , o , d}^{1} )}^{2}}{2 {σ}_{r , o , {d}^{2}}^{1}}}\end{matrix}}$$

$$p ( z ∈ TBP \vert {t}_{r , o , d}^{W} ( z ) ) = 1 - p ( z ∈ NP \vert {t}_{r , o , d}^{W} ( z ) )$$

In the equation, p,(z∈NP|t_{r,o,d}^{W}(z)) represents a probability that passenger z is a normal passenger; p(z∈TBP|t_{r,o,d}^{W}(z)) represents a probability that passenger z is a TB passenger; NP represents a set of all normal passengers; TBP represents a set of all TB passengers; t_{r,o,d}^{W}(z)represents the waiting time of passenger z, who chooses route r, at origin station o; μ_{r,o,d}⁰, σ_{r,o,d}⁰ and ω_{r,o,d}⁰ respectively represent a mean vector, a standard deviation vector and a weight vector of the normal waiting time of normal passengers, who choose route r, at origin station o; μ_{r,o,d}¹, σ_{r,o,d}¹ and ω_{r,o,d}¹ respectively represent a mean vector, a standard deviation vector and a weight vector of the turn-back time of TB passengers, who choose route r, at origin station o.

The train and station data acquisition module 203 is configured to acquire the maximum number of trains passengers have to wait for and the maximum number of turn-back stations.

The normal waiting time distribution model establishing module 204 is configured to establish a normal waiting time distribution model for normal passengers boarding different trains according to the maximum number of trains and the normal waiting time.

The normal waiting time distribution model establishing module 204 specifically includes a normal waiting time distribution model establishing unit.

The normal waiting time distribution model establishing unit is configured to establish a normal waiting time distribution model according to the following equation:

$$p ( {t}_{r , o , d}^{W} ( z ) \vert {ω}_{r , o , d}^{0} , {μ}_{r , o , d}^{0} , {σ}_{r , o , d}^{0} ) = {\sum }_{i = 1}^{{K}_{r , o , d}^{0}} ( {ω}_{r , o , d}^{0 , i} \frac{1}{\sqrt{2 π} \cdot {σ}_{r , o , d}^{0 , i}} {e}^{\frac{- {( {t}_{r , o , d}^{W} ( z ) - {μ}_{r , o , d}^{0} )}^{2}}{2 {σ}_{r , o , {d}^{2}}^{0 , i}}} )$$

In the equation, K_{r,o,d}⁰ represents the maximum number of trains that passenger z who chooses route r needs to wait at origin station o; p(t_{r,o,d}^{W}(z)|ω_{r,o,d}⁰,μ_{r,o,d}⁰,σ_{r,o,d}⁰) represents a probability density function for the distribution of all normal waiting time; ω_{r,o,d}⁰=(ω_{r,o,d}^{0,1},ω_{r,o,d}^{0,2}, . . . ω_{r,o,d}^{0,i}, . . . , ω_{r,o,d}^{0,K}^{_{r,o,d}}^{⁰}) represents a weight vector for the waiting time of normal passengers waiting for an i-th metro; μ_{r,o,d}⁰=(μ_{r,o,d}^{0,1},μ_{r,o,d}^{0,2}, . . . , μ_{r,o,d}^{0,i}, . . . , μ_{r,o,d}^{0,K}^{_{r,o,d}}^{⁰}) and σ_{r,o,d}⁰=(σ_{r,o,d}^{0,1},σ_{r,o,d}^{0,2}, . . . σ_{r,o,d}^{0,i}, . . . , σ_{r,o,d}^{0,K}^{_{r,o,d}}^{⁰}) respectively represent a mean vector and a standard deviation vector of the normal waiting time of normal passengers waiting for the i-th metro.

The turn-back time distribution model establishing module 205 is configured to establish a turn-back time distribution model for TB passengers choosing different turn-back stations according to the maximum number of turn-back stations and the turn-back time.

The turn-back time distribution model establishing module 205 specifically includes a turn-back time distribution model establishing unit.

The turn-back time distribution model establishing unit is configured to establish a turn-back time distribution model according to the following equation:

$$p ( {t}_{r , o , d , j}^{TB} \vert {ω}_{r , o , d}^{1} , {μ}_{r , o , d}^{1} , {σ}_{r , o , d}^{1} ) = {\sum }_{j = 1}^{{K}_{r , o , d}^{1}} ( {ω}_{r , o , d}^{1 , i} \frac{1}{\sqrt{2 π} \cdot {σ}_{r , o , d}^{1 , i}} {e}^{\frac{- {( {t}_{r , o , d , j}^{TB} - {μ}_{r , o , d}^{1 , j} )}^{2}}{2 {σ}_{r , o , {d}^{2}}^{1 , j}}} )$$

In the equation, p(t_{r,o,d,j}^{TB}|ω_{r,o,d}¹,μ_{r,o,d}¹σ_{r,o,d}¹) represents a probability density function for the distribution of all turn-back time; K_{r,o,d}¹ represents the maximum number of turn-back stations; t_{r,o,d,j}^{TB} represents an average turn-back time of TB passengers between origin station o and turn-back station s_{r,o,d}^{j} on route r; ω_{r,o,d}¹=(ω_{r,o,d}^{1,1}, . . . , ω_{r,o,d}^{1,j}, . . . , ω_{r,o,d}^{1,K}^{_{r,o,d}}^{¹}) represents a weight vector for the turn-back time of TB passenger at a j-th turn-back station; μ_{r,o,d}¹=(μ_{r,o,d}^{1,1}, . . . , μ_{r,o,d}^{1,j}, . . . , μ_{r,o,d}^{1,K}^{_{r,o,d}}^{^{tb}}) and σ_{r,o,d}¹=(σ_{r,o,d}^{1,1}, . . . σ_{r,o,d}^{1,j}, . . . , σ_{r,o,d}^{1,K}^{_{r,o,d}}^{⁰}) represent a mean vector and a standard deviation vector of the turn-back time of TB passengers at the j-th turn-back station, respectively.

The joint posterior probability calculation module 206 is configured to calculate a joint posterior probability of parameters in the passenger choice behavior model, the normal waiting time distribution model and the turn-back time distribution model by using a Bayesian model to obtain the joint posterior probability of the parameters of each model.

The joint posterior probability calculation module 206 specifically includes a joint posterior probability initial expression generating unit, a parameter joint prior probability function determining unit, a normal waiting time probability calculating unit, an observation data likelihood function determining unit and a parameter joint posterior probability generating unit.

The joint posterior probability initial expression generating unit is configured to take the normal waiting time as observation data and the probability distribution function of the normal waiting time of normal passengers taking different trains as a likelihood function, and obtain an initial expression of the joint posterior probability of the parameters in the normal waiting time distribution model according to the Bayesian equation.

The parameter joint prior probability function determining unit is configured to determine a joint prior probability function of the parameters according to mean, standard deviation and weight vectors of the normal waiting time of normal passengers waiting for an i-th metro.

The normal waiting time probability calculating unit is configured to calculate a probability of the waiting time of normal passengers according to mean, standard deviation and weight vectors of the normal waiting time of normal passengers, who choose route r, at origin station o.

The observation data likelihood function determining unit is configured to determine a likelihood function of the observation data based on the observation data.

The parameter joint posterior probability generating unit is configured to determine an actual joint posterior probability of the parameters according to the initial expression of the joint posterior probability of the parameters, the joint prior probability function, the probability of the normal waiting time of passengers and the likelihood function of the observation data.

The parameter estimation module 207 is configured to use a NUTS algorithm to estimate the parameters in each joint posterior probability to obtain estimated parameters.

The identification module 208 is configured to identify TB passengers, turn-back stations and boarding trains of TB passengers and boarding trains of normal passengers according to the estimated parameters to obtain an identification result.

The waiting time and loading rate calculation module 209 is configured to calculate the waiting time at each station and a loading rate in each running section according to the identification result.

Since the system disclosed in the embodiment corresponds to the method disclosed in the embodiment, the description is relatively simple. For relevant information, reference is made to the description of the method.

Several embodiments are used for illustration of the principles and implementation methods of the present disclosure. The description of the embodiments is used to help illustrate the method and its core principles of the present disclosure. In addition, those skilled in the art can make various modifications in terms of specific embodiments and scope of application in accordance with the teachings of the present disclosure. In conclusion, the content of this specification shall not be construed as a limitation to the present disclosure.

What is claimed is:

1. A method for identifying traveling backward (TB) passengers and boarding trains in rail transit, comprising:
acquiring data of ridership from an automatic fare collection (AFC) system, and determining a waiting time of passengers according to the ridership data, wherein the waiting time comprises a normal waiting time of normal passengers and a turn-back time of TB passengers; the normal waiting time is a time when the normal passengers wait at a station for a train directly into a destination station; the turn-back time is the sum of an in-vehicle time when the TB passengers travel in an opposite direction and a waiting time of the TB passengers at an origin station and a turn-back station;
establishing a passenger choice behavior model according to the waiting time of the passengers, wherein a passenger choice behavior comprises normal travel and TB;
acquiring the maximum number of trains the passengers have to wait for and the maximum number of turn-back stations;
establishing a normal waiting time distribution model for normal passengers boarding different trains according to the maximum number of trains and the normal waiting time;
establishing a turn-back time distribution model for TB passengers choosing different turn-back stations according to the maximum number of turn-back stations and the turn-back time;
calculating a joint posterior probability of parameters in the passenger choice behavior model, the normal waiting time distribution model and the turn-back time distribution model by using a Bayesian model to obtain the joint posterior probability of the parameters of each model;
using a no-u-turn sampler (NUTS) algorithm to estimate the parameters in each joint posterior probability to obtain estimated parameters; and
identifying TB passengers, turn-back stations and boarding trains of TB passengers and boarding trains of normal passengers according to the estimated parameters to obtain an identification result.

2. The method for identifying TB passengers and boarding trains in rail transit according to claim 1, wherein the establishing a passenger choice behavior model according to the waiting time of the passengers specifically comprises:
establishing a passenger choice behavior model according to the following equation:
$$p ( z ∈ NP \vert {t}_{r , o , d}^{W} ( z ) ) = \frac{{ω}_{r , o , d}^{0} \frac{1}{\sqrt{2 π} \cdot {σ}_{r , o , d}^{0}} {e}^{\frac{- {( {t}_{r , o , d}^{W} ( z ) - {μ}_{r , o , d}^{0} )}^{2}}{2 {σ}_{r , o , {d}^{2}}^{0}}}}{\begin{matrix}{ω}_{r , o , d}^{0} \frac{1}{\sqrt{2 π} \cdot {σ}_{r , o , d}^{0}} {e}^{\frac{- {( {t}_{r , o , d}^{W} ( z ) - {μ}_{r , o , d}^{0} )}^{2}}{2 {σ}_{r , o , {d}^{2}}^{0}}} + \\ {ω}_{r , o , d}^{1} \frac{1}{\sqrt{2 π} \cdot {σ}_{r , o , d}^{1}} {e}^{\frac{- {( {t}_{r , o , d}^{W} ( z ) - {μ}_{r , o , d}^{1} )}^{2}}{2 {σ}_{r , o , {d}^{2}}^{1}}}\end{matrix}}$$
$$p ( z ∈ TBP \vert {t}_{r , o , d}^{W} ( z ) ) = 1 - p ( z ∈ NP \vert {t}_{r , o , d}^{W} ( z ) )$$
wherein, p(z∈NP|t _{r,o,d}^{W}(z)) represents a probability that passenger z is a normal passenger; p(z∈TBP|t_{r,o,d}^{W}(z)) represents a probability that passenger z is a TB passenger; NP represents a set of all normal passengers; TBP represents a set of all TB passengers; t_{r,o,d}^{W}(z) represents the waiting time of passenger z, who chooses route r, at origin station o; μ_{r,o,d}⁰, σ_{r,o,d}⁰ and ω_{r,o,d}⁰ respectively represent a mean vector, a standard deviation vector and a weight vector of the normal waiting time of normal passengers, who choose route r, at origin station o; μ_{r,o,d}¹, σ_{r,o,d}¹ and ω_{r,o,d}¹ respectively represent a mean vector, a standard deviation vector and a weight vector of the turn-back time of TB passengers, who choose route r, at origin station o.

3. The method for identifying TB passengers and boarding trains in rail transit according to claim 2, wherein the establishing a normal waiting time distribution model for normal passengers boarding different trains according to the maximum number of trains and the normal waiting time specifically comprises:
establishing a normal waiting time distribution model according to the following equation:
$$p ( {t}_{r , o , d}^{W} ( z ) \vert {ω}_{r , o , d}^{0} , {μ}_{r , o , d}^{0} , {σ}_{r , o , d}^{0} ) = {\sum }_{i = 1}^{{K}_{r , o , d}^{0}} ( {ω}_{r , o , d}^{0 , i} \frac{1}{\sqrt{2 π} \cdot {σ}_{r , o , d}^{0 , i}} {e}^{\frac{- {( {t}_{r , o , d}^{W} ( z ) - {μ}_{r , o , d}^{0 , i} )}^{2}}{2 {σ}_{r , o , {d}^{2}}^{0 , i}}} )$$
wherein, K_{r,o,d}⁰ represents the maximum number of trains that passenger z who chooses route r needs to wait at origin station o; p(t_{r,o,d}^{W}(z)|ω_{r,o,d}⁰,μ_{r,o,d}⁰,σ_{r,o,d}⁰) represents a probability density function for the distribution of all normal waiting time; ω_{r,o,d}⁰=(ω_{r,o,d}^{0,1},ω_{r,o,d}^{0,2}, . . . ω_{r,o,d}^{0,i}, . . . , ω_{r,o,d}^{0,K}^{_{r,o,d}}^{⁰}) represents a weight vector for the waiting time of normal passengers waiting for an i-th metro; μ_{r,o,d}⁰=(μ_{r,o,d}^{0,1},μ_{r,o,d}^{0,2}, . . . μ_{r,o,d}^{0,i}, . . . , μ_{r,o,d}^{0,K}^{_{r,o,d}}^{⁰}) and σ_{r,o,d}⁰=(σ_{r,o,d}^{0,1},σ_{r,o,d}^{0,2}, . . . σ_{r,o,d}^{0,i}, . . . , σ_{r,o,d}^{0,K}^{_{r,o,d}}^{⁰}) respectively represent a mean vector and a standard deviation vector of the normal waiting time of normal passengers waiting for the i-th metro;
the establishing a turn-back time distribution model for TB passengers choosing different turn-back stations according to the maximum number of turn-back stations and the turn-back time specifically comprises:
establishing a turn-back time distribution model according to the following equation:
$$p ( {t}_{r , o , d , j}^{TB} \vert {ω}_{r , o , d}^{1} , {μ}_{r , o , d}^{1} , {σ}_{r , o , d}^{1} ) = {\sum }_{j = 1}^{{K}_{r , o , d}^{1}} ( {ω}_{r , o , d}^{1 , i} \frac{1}{\sqrt{2 π} \cdot {σ}_{r , o , d}^{1 , i}} {e}^{\frac{- {( {t}_{r , o , d , j}^{TB} - {μ}_{r , o , d}^{1 , j} )}^{2}}{2 {σ}_{r , o , {d}^{2}}^{1 , j}}} )$$
wherein, p(t_{r,o,d,j}^{TB}|ω_{r,o,d}¹,μ_{r,o,d}¹,σ_{r,o,d}¹) represents a probability density function for the distribution of all turn-back time; K_{r,o,d}¹ represents the maximum number of turn-back stations; t_{r,o,d,j}^{TB} represents an average turn-back time of TB passengers between origin station o and turn-back station s_{r,o,d}^{j} on route r; ω_{r,o,d}¹=(ω_{r,o,d}^{1,1}, . . . , ω_{r,o,d}^{1,j}, . . . , ω_{r,o,d}^{1,K}^{_{r,o,d}}^{¹}) represents a weight vector for the turn-back time of TB passenger at a j-th turn-back station; μ_{r,o,d}¹=(μ_{r,o,d}^{1,1}, . . . , μ_{r,o,d}^{1,j}, . . . , μ_{r,o,d}^{1,K}^{_{r,o,d}}^{^{tb}}) and σ_{r,o,d}¹=(σ_{r,o,d}^{1,1}, . . . σ_{r,o,d}^{1,j}, . . . , σ_{r,o,d}^{1,K}^{_{r,o,d}}^{¹}) represent a mean vector and a standard deviation vector of the turn-back time of TB passengers at the j-th turn-back station, respectively.

4. The method for identifying TB passengers and boarding trains in rail transit according to claim 3, wherein the calculating a joint posterior probability of parameters in the passenger choice behavior model, the normal waiting time distribution model and the turn-back time distribution model by using a Bayesian model to obtain the joint posterior probability of the parameters of each model specifically comprises:
taking the normal waiting time as observation data and the probability distribution function of the normal waiting time of normal passengers taking different trains as a likelihood function, and obtaining an initial expression of the joint posterior probability of the parameters in the normal waiting time distribution model according to the Bayesian equation;
determining a joint prior probability function of the parameters according to mean, standard deviation and weight vectors of the normal waiting time of normal passengers waiting for the i-th metro;
calculating a probability of the waiting time of passengers according to the mean, standard deviation and weight vectors of the normal waiting time of normal passengers, who choose route r, at origin station o;
determining a likelihood function of the observation data based on the observation data; and
determining an actual joint posterior probability of parameters according to the initial expression of the joint posterior probability of parameters, the joint prior probability function, the probability of the normal waiting time of passengers and the likelihood function of the observation data.

5. The method for identifying TB passengers and boarding trains in rail transit according to claim 4, wherein after identifying TB passengers, turn-back stations and boarding trains of TB passengers and boarding trains of normal passengers according to the estimated parameters to obtain an identification result, the method further comprises:
calculating the waiting time at each station and a loading rate in each running section according to the identification result.

6. A system for identifying TB passengers and boarding trains in rail transit, comprising:
a ridership data acquisition module, for acquiring data of ridership from an AFC system, and determining a waiting time of passengers according to the ridership data, wherein the waiting time comprises a normal waiting time of normal passengers and a turn-back time of TB passengers; the normal waiting time is a time when the normal passengers wait at a station for a train directly into a destination station; the turn-back time is the sum of an in-vehicle time when the TB passengers travel in an opposite direction and a waiting time of the TB passengers at an origin station and a turn-back station;
a passenger choice behavior model establishing module, for establishing a passenger choice behavior model according to the waiting time of the passengers, wherein a passenger choice behavior comprises normal travel and TB;
a train and station data acquisition module, for acquiring the maximum number of trains passengers have to wait for and the maximum number of turn-back stations;
a normal waiting time distribution model establishing module, for establishing a normal waiting time distribution model for normal passengers boarding different trains according to the maximum number of trains and the normal waiting time;
a turn-back time distribution model establishing module, for establishing a turn-back time distribution model for TB passengers choosing different turn-back stations according to the maximum number of turn-back stations and the turn-back time;
a joint posterior probability calculation module, for calculating a joint posterior probability of parameters in the passenger choice behavior model, the normal waiting time distribution model and the turn-back time distribution model by using a Bayesian model to obtain the joint posterior probability of the parameters of each model;
a parameter estimation module, for using a NUTS algorithm to estimate the parameters in each joint posterior probability to obtain estimated parameters; and
an identification module, for identifying TB passengers, turn-back stations and boarding trains of TB passengers and boarding trains of normal passengers according to the estimated parameters to obtain an identification result.

7. The system for identifying TB passengers and boarding trains in rail transit according to claim 6, wherein the passenger choice behavior model establishing module specifically comprises:
a passenger choice behavior model establishing unit, for establishing a passenger choice behavior model according to the following equation:
$$p ( z ∈ NP \vert {t}_{r , o , d}^{W} ( z ) ) = \frac{{ω}_{r , o , d}^{0} \frac{1}{\sqrt{2 π} \cdot {σ}_{r , o , d}^{0}} {e}^{\frac{- {( {t}_{r , o , d}^{W} ( z ) - {μ}_{r , o , d}^{0} )}^{2}}{2 {σ}_{r , o , {d}^{2}}^{0}}}}{\begin{matrix}{ω}_{r , o , d}^{0} \frac{1}{\sqrt{2 π} \cdot {σ}_{r , o , d}^{0}} {e}^{\frac{- {( {t}_{r , o , d}^{W} ( z ) - {μ}_{r , o , d}^{0} )}^{2}}{2 {σ}_{r , o , {d}^{2}}^{0}}} + \\ {ω}_{r , o , d}^{1} \frac{1}{\sqrt{2 π} \cdot {σ}_{r , o , d}^{1}} {e}^{\frac{- {( {t}_{r , o , d}^{W} ( z ) - {μ}_{r , o , d}^{1} )}^{2}}{2 {σ}_{r , o , {d}^{2}}^{1}}}\end{matrix}}$$
$$p ( z ∈ TBP \vert {t}_{r , o , d}^{W} ( z ) ) = 1 - p ( z ∈ NP \vert {t}_{r , o , d}^{W} ( z ) )$$
wherein, p(z∈NP|t_{r,o,d}^{W}(z)) represents a probability that passenger z is a normal passenger; p(z∈TBP|t_{r,o,d}^{W}(z)) represents a probability that passenger z is a TB passenger; NP represents a set of all normal passengers; TBP represents a set of all TB passengers; t_{r,o,d}^{W}(z) represents the waiting time of passenger z, who chooses route r, at origin station o; μ_{r,o,d}⁰, σ_{r,o,d}⁰ and ω_{r,o,d}⁰ respectively represent a mean vector, a standard deviation vector and a weight vector of the normal waiting time of normal passengers, who choose route r, at origin station o; μ_{r,o,d}¹, σ_{r,o,d}¹ and ω_{r,o,d}¹ respectively represent a mean vector, a standard deviation vector and a weight vector of the turn-back time of TB passengers, who choose route r, at origin station o.

8. The system for identifying TB passengers and boarding trains in rail transit according to claim 7, wherein
the normal waiting time distribution model establishing module specifically comprises:
a normal waiting time distribution model establishing unit, for establishing a normal waiting time distribution model according to the following equation:
$$p ( {t}_{r , o , d}^{W} ( z ) \vert {ω}_{r , o , d}^{0} , {μ}_{r , o , d}^{0} , {σ}_{r , o , d}^{0} ) = {\sum }_{i = 1}^{{K}_{r , o , d}^{0}} ( {ω}_{r , o , d}^{0 , i} \frac{1}{\sqrt{2 π} \cdot {σ}_{r , o , d}^{0 , i}} {e}^{\frac{- {( {t}_{r , o , d}^{W} ( z ) - {μ}_{r , o , d}^{0 , i} )}^{2}}{2 {σ}_{r , o , {d}^{2}}^{0 , i}}} )$$
wherein, K_{r,o,d}⁰ represents the maximum number of trains that passenger z who chooses route r needs to wait at origin station o;
p(t_{r,o,d}^{W}(z)|ψ_{r,o,d}⁰,μ_{r,o,d}⁰,σ_{r,o,d}⁰) represents a probability density function for the distribution of all normal waiting time;
ω_{r,o,d}⁰=(ω_{r,o,d}^{0,1},ω_{r,o,d}^{0,2}, . . . ω_{r,o,d}^{0,i}, . . . , ω_{r,o,d}^{0,K}^{_{r,o,d}}^{⁰}) represents a weight vector for the waiting time of normal passengers waiting for an i-th metro; μ_{r,o,d}⁰=(μ_{r,o,d}^{0,1},μ_{r,o,d}^{0,2}, . . . μ_{r,o,d}^{0,i}, . . . , μ_{r,o,d}^{0,K}^{_{r,o,d}}^{⁰}) and σ_{r,o,d}⁰=(σ_{r,o,d}^{0,1},σ_{r,o,d}^{0,2}, . . . σ_{r,o,d}^{0,K}^{_{r,o,d}}^{⁰}) respectively represent a mean vector and a standard deviation vector of the normal waiting time of normal passengers waiting for the i-th metro;
the turn-back time distribution model establishing module specifically comprises:
a turn-back time distribution model establishing unit, for establishing a turn-back time distribution model according to the following equation:
$$p ( {t}_{r , o , d , j}^{TB} \vert {ω}_{r , o , d}^{1} , {μ}_{r , o , d}^{1} , {σ}_{r , o , d}^{1} ) = {\sum }_{j = 1}^{{K}_{r , o , d}^{1}} ( {ω}_{r , o , d}^{1 , i} \frac{1}{\sqrt{2 π} \cdot {σ}_{r , o , d}^{1 , i}} {e}^{\frac{- {( {t}_{r , o , d , j}^{TB} - {μ}_{r , o , d}^{1 , j} )}^{2}}{2 {σ}_{r , o , {d}^{2}}^{1 , j}}} )$$
wherein, p(t_{r,o,d,j}^{TB}|ω_{r,o,d}¹,μ_{r,o,d}¹,σ_{r,o,d}¹) represents a probability density function for the distribution of all turn-back time; K_{r,o,d}¹ represents the maximum number of turn-back stations; t_{r,o,d,j}^{TB} represents an average turn-back time of TB passengers between origin station o and turn-back station s_{r,o,d}^{j} on route r; ω_{r,o,d}¹=(ω_{r,o,d}^{1,1}, . . . , ω_{r,o,d}^{1,j}, . . . , ω_{r,o,d}^{1,K}^{_{r,o,d}}^{¹}) represents a weight vector for the turn-back time of TB passenger at a j-th turn-back station; μ_{r,o,d}¹=(μ_{r,o,d}^{1,1}, . . . , μ_{r,o,d}^{1,j}, . . . , μ_{r,o,d}^{1,K}^{_{r,o,d}}^{^{tb}}) and σ_{r,o,d}¹=(σ_{r,o,d}^{1,1}, . . . σ_{r,o,d}^{1,j}, . . . , σ_{r,o,d}^{1,K}^{_{r,o,d}}^{¹}) represent a mean vector and a standard deviation vector of the turn-back time of TB passengers at the j-th turn-back station, respectively.

9. The system for identifying TB passengers and boarding trains in rail transit according to claim 8, wherein the joint posterior probability calculation module specifically comprises:
a joint posterior probability initial expression generating unit, for taking the normal waiting time as observation data and the probability distribution function of the normal waiting time of normal passengers taking different trains as a likelihood function, and obtaining an initial expression of the joint posterior probability of the parameters in the normal waiting time distribution model according to the Bayesian equation;
a parameter joint prior probability function determining unit, for determining a joint prior probability function of the parameters according to mean, standard deviation and weight vectors of the normal waiting time of normal passengers waiting for an i-th metro;
a normal waiting time probability calculating unit, for calculating a probability of the waiting time of normal passengers according to the mean, standard deviation and weight vectors of the normal waiting time of normal passengers, who choose route r, at origin station o;
an observation data likelihood function determining unit, for determining a likelihood function of the observation data based on the observation data; and
a parameter joint posterior probability generating unit, for determining an actual joint posterior probability of the parameters according to the initial expression of the joint posterior probability, the joint prior probability function, the probability of the normal waiting time of passengers and the likelihood function of the observation data.

10. The system for identifying TB passengers and boarding trains in rail transit according to claim 9, wherein the system further comprises:
a waiting time and loading rate calculation module, for calculating the waiting time at each station and a loading rate in each running section according to the identification result.
